(19) United States
(12) Patent Application Publication
(10) Pub. No.: US 2026/0358738 A1
(43) Pub. Date: Nov. 12, 2026

(54) HEATING APPARATUS CONTROLLING POWER SUPPLIED TO HEATING MEMBER

(71) Applicant: CANON KABUSHIKI KAISHA, Tokyo (JP)

(72) Inventor: NOZOMU NAKAJIMA, Kanagawa (JP)

(21) Appl. No.: 19/177,820

(22) Filed: Apr. 14, 2025

(30) Foreign Application Priority Data
Apr. 22, 2024 (JP) 2024-069199

(51) Int. Cl. G03G 15/00; G03G 15/20

(52) U.S. Cl. CPC G03G 15/5004; G03G 15/2032; G03G 15/205; G03G 15/2064; G03G 15/80; G03G 2215/2035

(57) ABSTRACT

A heating apparatus comprises a first switch that adjusts power supplied from an AC power source to a heating member and a second switch provided in a power supply route. A noise immunity of the first switch with respect to exogenous noise coming from the AC power source is lower than a noise immunity of the second switch. In a period where a first rotational member and a second rotational member are in a non-rotating state, the second switch is controlled to a non-conductive state when a temperature is greater than a first threshold and is controlled to a conductive state when the temperature is less than a second threshold that is less than or equal to the first threshold.

### BACKGROUND OF THE INVENTION

### Field of the Invention

The present invention relates to a heating apparatus that controls the power supplied to a heating member.

### Description of the Related Art

An image forming apparatus that forms an image using toner fixes the toner image to a sheet using a heating apparatus that generates heat by being supplied with power from an AC power source. An electromagnetic relay is provided in the power supply route from the AC power source to the heating apparatus. Japanese Patent No. 3150760 describes a contact of an electromagnetic relay being controlled to a conductive state in an image forming state, and to a non-conductive state in a state other than the image forming state.

The operation time (state transition time) of an electromagnetic relay is longer than the operation time of a semiconductor switching element such as a TRIAC. This reduces the productivity of the heating apparatus. On the other hand, the noise immunity of a semiconductor switching element is lower than the noise immunity of an electromagnetic relay. For example, a semiconductor switching element can become conductive unintentionally due to exogenous noise from an AC power source, which causes the heating apparatus to emit heat and results in components reaching the end of their service life earlier.

### SUMMARY OF THE INVENTION

The disclosure provides a heating apparatus comprising: a first rotational member; a second rotational member that forms a nip with the first rotational member by contacting the first rotational member; a heating member that heats at least one of the first rotational member and the second rotational member; a temperature sensor disposed close to any one of the first rotational member, the second rotational member, or the heating member; a first switch that adjusts power supplied from an AC power source to the heating member; and a second switch provided in a power supply route along which the power is supplied from the AC power source to the heating member. A noise immunity of the first switch with respect to exogenous noise coming from the AC power source is lower than a noise immunity of the second switch. In a period where the first rotational member and the second rotational member are in a non-rotating state, the second switch: is controlled to a non-conductive state when a temperature detected by the temperature sensor is greater than a first threshold, without a reporting unit reporting an error pertaining to the temperature; and is controlled to a conductive state when the temperature detected by the temperature sensor is less than a second threshold that is less than or equal to the first threshold.

Further features of the present invention will become apparent from the following description of exemplary embodiments (with reference to the attached drawings).

### BRIEF DESCRIPTION OF THE DRAWINGS

FIGS. 1A and 1B are diagrams illustrating an image forming apparatus and a heating apparatus.

FIG. 2 is a diagram illustrating a power supply circuit.

FIG. 3 is a diagram illustrating a controller.

FIG. 4A is a diagram illustrating temperature transitions.

FIG. 4B is a diagram illustrating temperature transitions.

FIG. 4C is a diagram illustrating temperature transitions.

FIGS. 5A and 5B are diagrams illustrating a startup time of a plurality of process apparatuses involved in image formation.

FIG. 6 is a flowchart illustrating a control method.

FIG. 7A is a diagram illustrating temperature transitions.

FIG. 7B is a diagram illustrating temperature transitions.

FIG. 7C is a diagram illustrating temperature transitions.

FIG. 8 is a flowchart illustrating a control method.

FIG. 9 is a diagram illustrating temperature transitions.

FIG. 10 is a flowchart illustrating a control method.

FIG. 11A is a diagram illustrating temperature transitions.

FIG. 11B is a diagram illustrating temperature transitions.

FIG. 11C is a diagram illustrating temperature transitions.

FIG. 12 is a flowchart illustrating a control method.

FIG. 13 is a diagram illustrating temperature transitions.

FIG. 14 is a flowchart illustrating a control method.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### 1. First Embodiment

### 1-1. Image Forming Apparatus

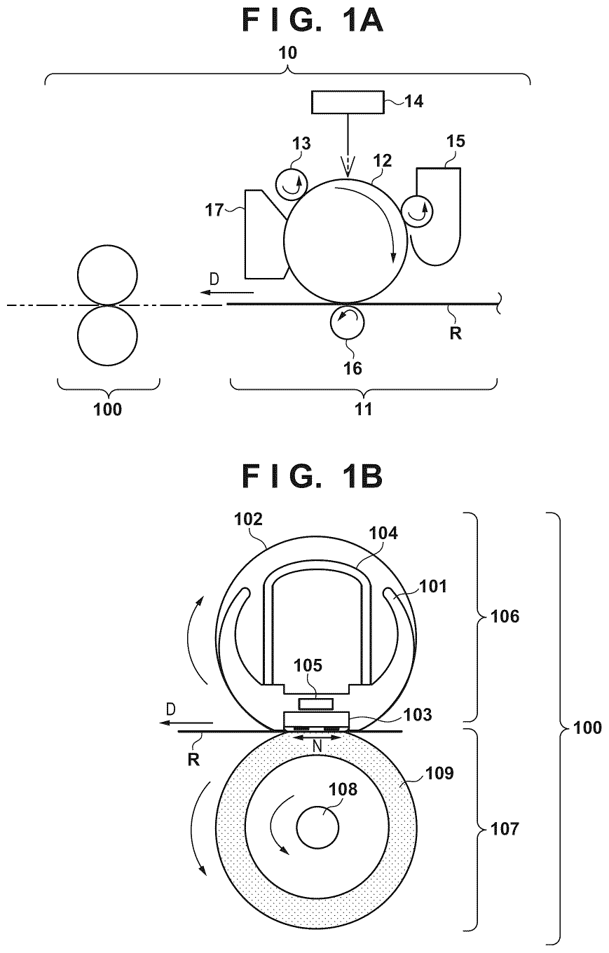

FIG. 1A illustrates an electrophotographic image forming apparatus 10. The image forming apparatus 10 includes an image forming section 11 that forms an unfixed toner image on a sheet R, and a heating apparatus 100 that plays a role in fixing the unfixed toner image on the sheet R to the sheet R. The image forming section 11 includes a photosensitive drum 12, a charging unit 13, an exposure unit 14, a developing unit 15, a transfer unit 16, and a cleaning unit 17. The photosensitive drum 12 is an image carrying member that is rotationally driven in the direction of the arrow indicated therein. The charging unit 13 includes a charging member (e.g., a charging roller or a charging wire) that charges the surface of the photosensitive drum 12. The exposure unit 14 includes a light source (e.g., a semiconductor laser or a light-emitting diode) that forms an electrostatic latent image on the surface of the photosensitive drum 12 by irradiating that surface with light based on image data. The developing unit 15 develops the electrostatic latent image using toner held in a toner receptacle, and forms a toner image. The transfer unit 16 includes a transfer member (e.g., a transfer roller, a transfer blade, or an intermediate transfer belt) that transfers the toner image from the photosensitive drum 12 to the sheet R. The cleaning unit 17 includes a cleaning member (e.g., a cleaning blade) that cleans the photosensitive drum 12.

The sheet R carrying the unfixed toner image is conveyed to the heating apparatus 100. The heating apparatus 100 is a fixing apparatus that fixes the toner image onto the sheet R by applying heat and pressure to the unfixed toner image and the sheet R. The sheet R that has passed through the heating apparatus 100 is discharged from the image forming apparatus 10.

### 1-2. Heating Apparatus

FIG. 1B illustrates the heating apparatus 100 provided in the image forming apparatus 10 in detail. The heating apparatus 100 includes a film guide unit 106 and a pressurizing roller 107. In particular, a fixing film 102 and the pressurizing roller 107 are both rotational members. The film guide unit 106 includes a holding member 101, the fixing film 102, a heater 103, a metal stay 104, and a temperature sensor 105. The holding member 101 is made of a heat-resistant resin and holds the heater 103. Furthermore, the holding member 101 guides the rotation of the fixing film 102, which is flexible and cylindrical in shape. The heater 103 is held by the holding member 101 in contact with an inner surface of the fixing film 102. The metal stay 104 prevents the holding member 101 from bending.

The pressurizing roller 107 includes a metal core 108 and an elastic layer 109. The material of the metal core 108 is a metal such as iron or aluminum. The material of the elastic layer 109 is silicone rubber or the like.

The temperature sensor 105 is a temperature sensor which is disposed near the heater 103 and which senses the temperature of the heater 103. Note that the temperature sensor 105 may be disposed so as to sense the temperature of the fixing film 102 or the pressurizing roller 107.

The film guide unit 106 is pressed against the pressurizing roller 107 by a spring or the like (not shown). A fixing nip N is formed between the fixing film 102 and the pressurizing roller 107 as a result. The pressurizing roller 107 is rotationally driven at a predetermined circumferential speed by a motor M1 (described later). The rotation of the pressurizing roller 107 generates friction between the pressurizing roller 107 and the fixing film 102 at the fixing nip N. This friction imparts a rotational force on the fixing film 102, and the fixing film 102 rotates while sliding along the heater 103.

### 1-3. Controller

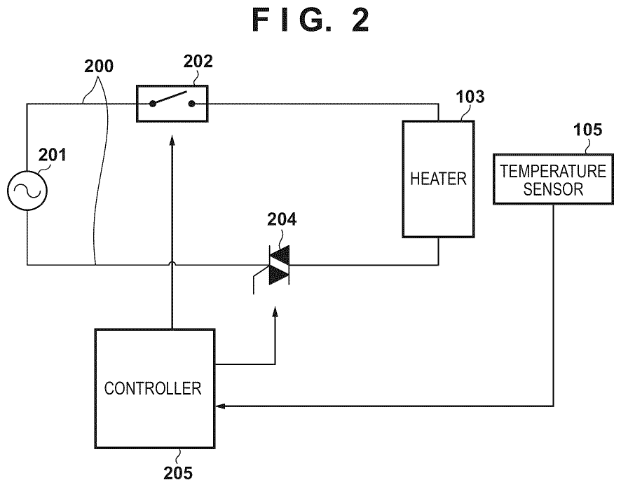

FIG. 2 illustrates a power supply circuit for supplying power from an AC power source 201 to the heater 103. The AC power source 201 is a commercial AC power source, for example. An electromagnetic relay 202 is provided in a power supply route 200 connecting the AC power source 201 to the heater 103. The contacts of the electromagnetic relay 202 are switched from a conductive state to a non-conductive state when there is no need to supply power from the AC power source 201 to the heater 103 (e.g., during a sleep state), when the temperature of the heater 103 is abnormally high, or the like. The control of the supply of power from the AC power source 201 to the heater 103 is executed by a TRIAC 204 and a controller 205. The controller 205 controls the power supplied from the AC power source 201 to the heater 103 via the TRIAC 204 such that the temperature of the heater 103 adheres to a target temperature. Specifically, the temperature of the heater 103, sensed by the temperature sensor 105, is input to the controller 205, and a predetermined operation (such as a PID control operation) is performed in the controller 205. “PID” is an acronym for “Proportional-Integral-Differential”. A control signal is then sent from the controller 205 to the TRIAC 204. The control signal controls the TRIAC 204 to be conductive or non-conductive.

### 1-4. Details of Controller

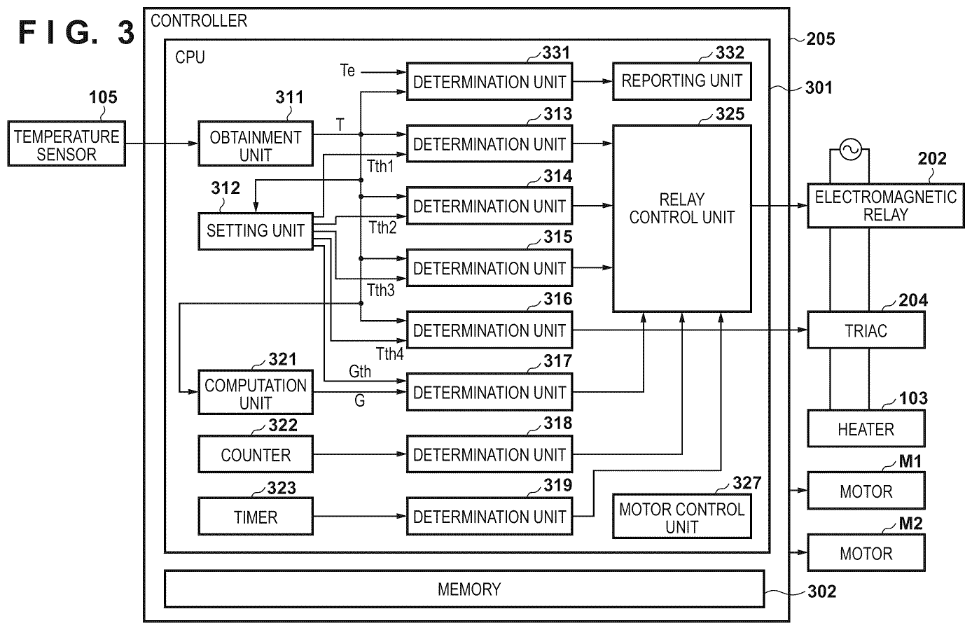

FIG. 3 illustrates the controller 205 in detail. A CPU 301 is a processor that implements various functions by executing a control program stored in a memory 302. Note that one or more of the plurality of functions described below may be implemented by an integrated circuit different from the CPU 301. Note that all the functions illustrated in FIG. 3 are not required. The functions which are required differ from embodiment to embodiment.

An obtainment unit 311 obtains a temperature T on the basis of a sensing signal output from the temperature sensor 105 when a predetermined obtainment condition is met. The obtainment unit 311 may obtain a statistical value by sampling a plurality of measurement results.

A determination unit 313 outputs a result of comparing the temperature T with a threshold Tth1 (a determination result) to a relay control unit 325. The threshold Tth1 is a threshold for forcing the electromagnetic relay 202 to turn off when the temperature T is trending upward. In particular, the threshold Tth1 functions to cut off power to the heater 103 when the TRIAC 204 has become uncontrollable due to exogenous noise. In the first embodiment, the threshold Tth1 is set to 100 °C, for example.

“Exogenous noise” refers to electrical noise that reaches the image forming apparatus 10 from the AC power source 201 via a power cable. “Noise immunity” refers to an upper limit level of the exogenous noise from the AC power source that a switching element can withstand without false firing. In other words, if the level of the exogenous noise is less than or equal to the upper limit level, the switching element will not falsely fire. However, if the level of the exogenous noise exceeds the upper limit level, the switching element will falsely fire. The noise immunity of the electromagnetic relay 202 to exogenous noise is higher than the noise immunity of a semiconductor switching element such as the TRIAC 204. For this reason, the electromagnetic relay 202 is less likely than the TRIAC 204 to turn on incorrectly due to exogenous noise.

A determination unit 314 outputs a result of comparing the temperature T with a threshold Tth2 (a determination result) to the relay control unit 325. The threshold Tth2 is a threshold for forcing the electromagnetic relay 202 to turn on when the temperature T is trending downward. The threshold Tth2 assists in shortening the startup time of the heating apparatus 100. In the first embodiment, the threshold Tth2 is set to 100 °C. Furthermore, in the first embodiment, the threshold Tth1 and the threshold Tth2 are equal, and thus the threshold Tth1 also functions as the threshold Tth2.

A determination unit 315 is used in the second and subsequent embodiments, and outputs a result of comparing the temperature T with a threshold Tth3 (a determination result) to the relay control unit 325. The threshold Tth3 is higher than the threshold Tth1, and assists in protecting the heating apparatus 100 from exogenous noise. A setting unit 312 may determine the threshold Tth3 on the basis of the temperature T over a predetermined period measured on the basis of a timer 323, and may set the threshold Tth3 in the determination unit 315.

A determination unit 316 is used in the second and subsequent embodiments, and outputs a result of comparing the temperature T with a threshold Tth4 (a determination result) to the relay control unit 325. The threshold Tth4 may be used instead of the threshold Tth1 when cleaning the heating apparatus 100.

A gradient computation unit 321 computes a gradient G of the temperature T, and outputs the gradient G to a determination unit 317. The determination unit 317 is used in the second and subsequent embodiments, and outputs a result of comparing the gradient G with a threshold Gth (a determination result) to the relay control unit 325. The gradient G indicates whether the temperature T is trending upward or downward.

A counter 322 counts the number of occurrences of a predetermined event, and outputs a result of the count (a count value C) to a determination unit 318. The predetermined event may be, for example, a transition from the temperature T rising to falling, falling to rising, or the like while in a standby state. The determination unit 318 is used in the second and subsequent embodiments, and outputs a result of comparing the count value C with a threshold Cth (a determination result) to the relay control unit 325. The threshold Cth, too, may be set by the setting unit 312. The threshold Cth assists in protecting the contacts of the electromagnetic relay 202, reducing operation noise, and the like.

The timer 323 starts counting time when the predetermined event occurs. A determination unit 319 is used in the second and subsequent embodiments, and outputs a result of comparing a timer value M with a threshold Mth (a determination result) to the relay control unit 325. The threshold Mth, too, may be set by the setting unit 312.

The relay control unit 325 controls the electromagnetic relay 202 to turn on (enter a conductive state), turn off (enter a non-conductive state), and the like on the basis of the determination results from the determination units 313 to 319 and a determination unit 331. The determination unit 331 determines whether the temperature T exceeds an error threshold Te (e.g., 250 °C), and outputs a result of the determination to a reporting unit 332 and the relay control unit 325. Te is a specified value. The reporting unit 332 outputs warning information indicating that the temperature T of the heater 103 is abnormally high. The warning information may be visual information displayed on a display apparatus, or acoustic information output from a speaker or an acoustic device. The warning information may be included and sent in an email or notification information. Accordingly, the information reporting unit 332 can include at least one of a display apparatus, a speaker, and a communication circuit.

A motor control unit 327 controls the motor M1 and a motor M2. The motor M1 is a drive source that rotationally drives the pressurizing roller 107. The motor M2 is a drive source for bringing the pressurizing roller 107 into contact with, and separating the pressurizing roller 107 from, the fixing film 102. The pressurizing roller 107 or the fixing film 102 may deform if the pressurizing roller 107 and the fixing film 102 are in constant contact. The separated state is effective for preventing such deformation.

### 1-5. Control Method

As illustrated in FIG. 2, the electromagnetic relay 202 and the TRIAC 204 are connected to the heater 103 in series. When both the electromagnetic relay 202 and the TRIAC 204 turn on, power is supplied from the AC power source 201 to the heater 103. When at least one of the electromagnetic relay 202 and the TRIAC 204 turns off, power is not supplied from the AC power source 201 to the heater 103. The operation time for the electromagnetic relay 202 to turn from off to on is relatively long. Accordingly, the TRIAC 204, which has a shorter operation time, is necessary to control the supply of power (adjust the temperature during image formation). However, the TRIAC 204 has relatively low noise immunity. The TRIAC 204 may turn on unintentionally due to exogenous noise. Accordingly, the electromagnetic relay 202 is necessary for safely cutting off the power.

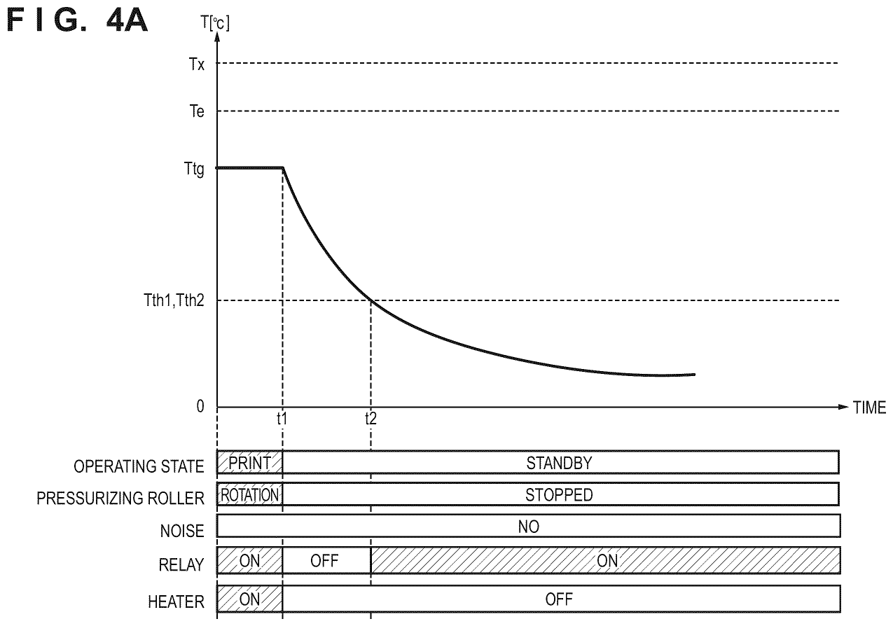

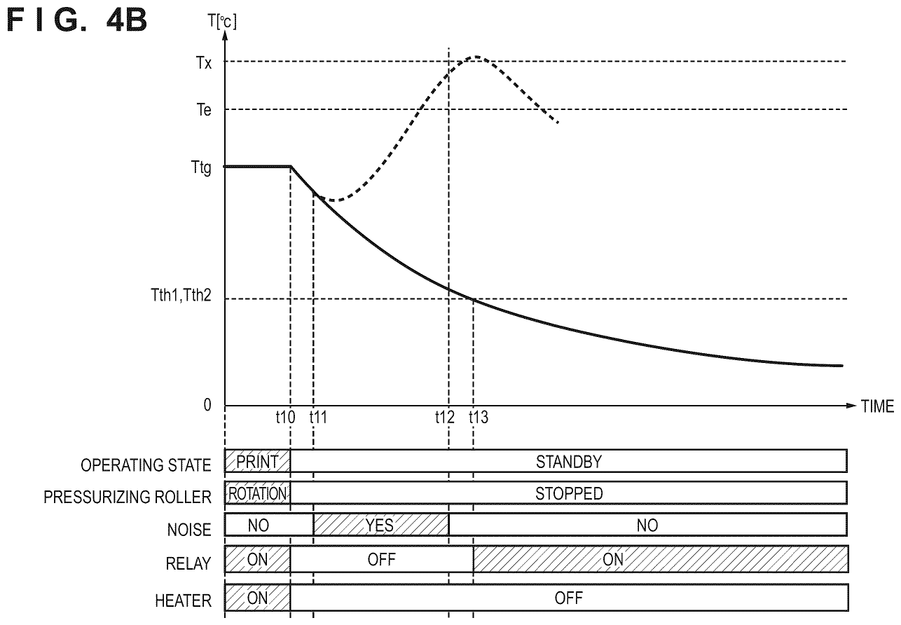

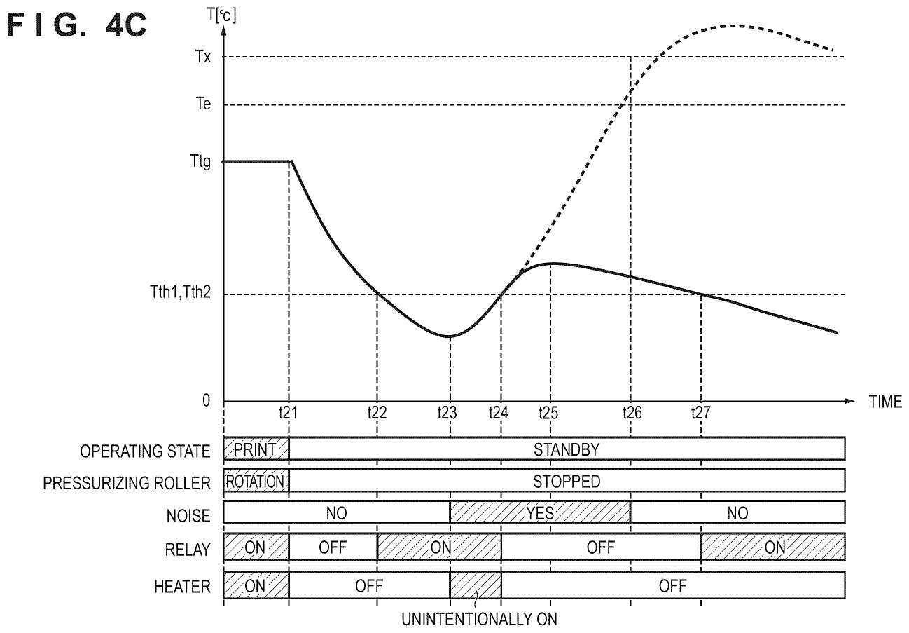

FIGS. 4A to 4C illustrate the operating state of the image forming apparatus 10 switching from a printing state to a standby state. The operating state of the image forming apparatus 10 is the printing state or the standby state. The state of the pressurizing roller 107 and the fixing film 102 is a rotating state or a stopped state (a non-rotating state). The state of exogenous noise is “present” or “absent”. “Absent” means that the level of exogenous noise is low enough that the TRIAC 204 does not falsely fire, and does not mean that exogenous noise is completely absent. The state of the electromagnetic relay 202 is on (a conductive state) or off (a non-conductive state). The state of the heater 103 is on (a heating state) or off (a stopped state). In particular, FIG. 4A illustrates a case where the TRIAC 204 has not been exposed to exogenous noise while in the standby state. The vertical axis represents the temperature T detected by the temperature sensor 105. The horizontal axis represents elapsed time.

Ttg represents a target temperature set when the image forming apparatus 10 prints. Ttg is 230 °C, for example. The CPU 301 may change the target temperature Ttg in accordance with the type of the sheet R (e.g., the thickness, the basis weight, the presence or absence of coating) or the like.

Te represents a threshold for reporting an error and stopping the operations of the image forming apparatus 10 when some kind of anomaly occurs in the heating apparatus 100 and the temperature of the heater 103 becomes excessively high. Te is 250 °C, for example. When the determination unit 331 determines that the temperature T has exceeded the threshold Te, the relay control unit 325 controls the contacts of the electromagnetic relay 202 to a non-conductive state. The supply of power from the AC power source 201 to the heater 103 is cut off as a result. The determination unit 331 may be implemented by a determination circuit such as a comparator. The reporting unit 332 outputs an error message (warning information) to an operation panel or the like of the image forming apparatus 10.

Tx represents a temperature at which the fixing film 102 and the pressurizing roller 107 will be damaged. Tx is 280 °C, for example. When the temperature T exceeds Tx, the surface layer of the fixing film 102 and the pressurizing roller 107 can melt, and the quality of the fixing can drop as a result. When the temperature T significantly exceeds Tx, the fixing film 102 may bond to the pressurizing roller 107, rendering the heating apparatus 100 unusable.

Tth1 and Tth2 are temperature thresholds for determining whether the contacts of the electromagnetic relay 202 are in the conductive state or the non-conductive state while in the standby state. In the standby state, the heater 103 stops generating heat, and thus the temperature T is expected to decrease gradually. When the temperature T falls below Tth2 in the standby state, the controller 205 controls the contacts of the electromagnetic relay 202 to the conductive state. This improves the productivity of the heating apparatus 100. On the other hand, when false firing occurs in the TRIAC 204 while the contacts of the electromagnetic relay 202 are in the conductive state, the heater 103 starts generating heat unintentionally. When the temperature T exceeds Tth1 during the standby state, the relay control unit 325 controls the contacts of the electromagnetic relay 202 to the non-conductive state. In the first embodiment, Tth1 and Tth2 are equal, and are both 100 °C, for example.
Obtaining Tth1 and Tth2

Tth1 is a temperature threshold for forcing the electromagnetic relay 202 to turn off to protect the heating apparatus 100. Tth2 is a temperature threshold for forcing the electromagnetic relay 202 to turn on to increase the productivity of the heating apparatus 100.

Tth1 and Tth2 are set to a temperature between 50 °C and 200 °C, for example. The reason why Tth2 is set to greater than or equal to 50 °C will be described first. In the image forming apparatus 10, a First Printout Time (FPOT), from when a print job is received from a host computer or the like to when the first printed material is output, is viewed as important. As the temperature of the heating apparatus 100 decreases, the time required to raise the temperature T of the heating apparatus 100 to the target temperature Ttg at which printing is possible (the startup time) increases. As a result, as the temperature T decreases, the FPOT increases. For example, when the temperature T is less than 50 °C, the startup time required for the temperature T of the heating apparatus 100 to reach the target temperature Ttg acts as a bottleneck for the FPOT. In other words, when the temperature T is less than 50 °C, the startup time of the heating apparatus 100 is longer than the startup time of other devices in the image forming apparatus 10 (e.g., the charging unit 13 and the exposure unit 14). When the contacts of the electromagnetic relay 202 are in the non-conductive state while in the standby state, it is also necessary for the contacts of the electromagnetic relay 202 to transition from the non-conductive state to the conductive state. This transition time is also added to the startup time of the heating apparatus 100.

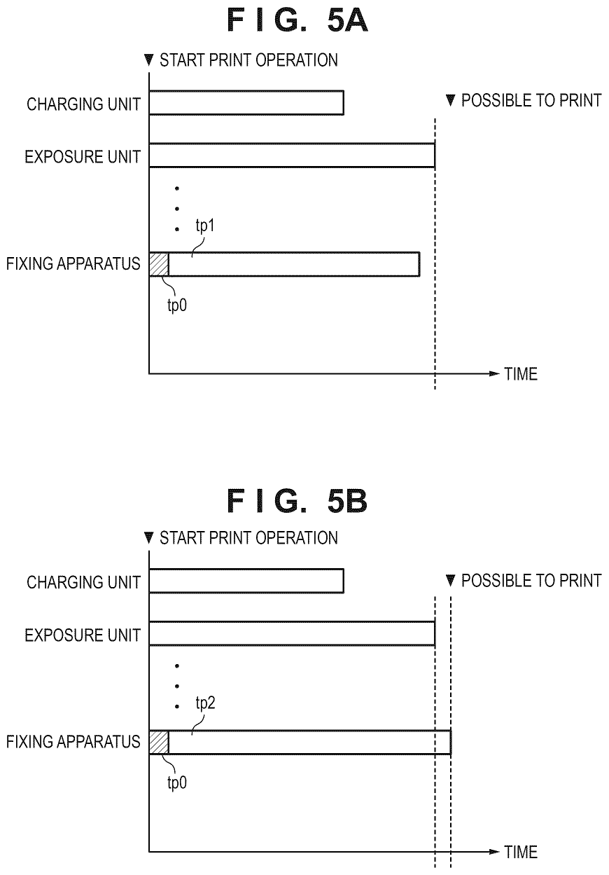

FIG. 5A illustrates an example of each startup time of a plurality of the process apparatuses (e.g., the charging unit 13, the exposure unit 14, and the heating apparatus 100) when the temperature T is greater than or equal to 50 °C “Process apparatus” refers to an apparatus involved in the electrophotographic process. FIG. 5B illustrates an example of the startup times of the charging unit 13, the exposure unit 14, and the heating apparatus 100 when the temperature T is less than 50 °C tp0 represents the operation time of the electromagnetic relay 202. tp1 represents the startup time of the heater 103 when the temperature T is greater than or equal to 50 °C tp2 represents the startup time of the heater 103 when the temperature T is less than 50 °C.

As illustrated in FIGS. 5A and 5B, when the temperature T is greater than or equal to 50 °C, the heating time required to raise the temperature T of the heating apparatus 100 to greater than or equal to the target temperature (the startup time tp1) is less than the startup time tp2 when the temperature T is less than 50 °C. Accordingly, the startup time of the heating apparatus 100 including the operation time tp0 of the electromagnetic relay 202 (the sum of tp0 and tp1) is shorter than the startup time of the exposure unit 14.

As illustrated in FIG. 5B, the startup time tp2 of the heating apparatus 100 when the temperature T is less than 50 °C is longer than the startup time tp1 when the temperature T is greater than or equal to 50 °C. Accordingly, the startup time of the heating apparatus 100 including the operation time tp0 of the electromagnetic relay 202 (tp0+tp2) is longer than the startup time of the exposure unit 14. In other words, in FIG. 5B, the heating apparatus 100 acts as a bottleneck for the FPOT of the image forming apparatus 10. To ensure the heating apparatus 100 does not act as a bottleneck, the contacts of the electromagnetic relay 202 may be controlled to the conductive state in advance when the temperature T is less than 50 °C. Doing so eliminates the need for the operation time tp0 of the electromagnetic relay 202, which makes the startup time of the heating apparatus 100 shorter than the startup time of the exposure unit 14. In this manner, the FPOT is reduced by controlling the contacts of the electromagnetic relay 202 to the conductive state when the temperature T is less than 50 °C.

The reason why Tth1 is set to less than or equal to 200 °C will be described next. In the standby state, the fixing film 102 and the pressurizing roller 107 are not rotating. When exogenous noise enters the TRIAC 204 from the AC power source 201 while in the standby state, the TRIAC 204 falsely fires, and the heater 103 generates heat. If, for example, the contacts of the electromagnetic relay 202 are controlled to the non-conductive state before the temperature T exceeds 200 °C, the temperature T will not exceed the threshold Te (=250 °C), even when taking temperature overshoot into account. In other words, when the temperature T is greater than or equal to 200 °C, the contacts of the electromagnetic relay 202 are controlled to the non-conductive state. Doing so suppresses situations where the image forming apparatus 10 stops frequently when the TRIAC 204 is exposed to exogenous noise.

In this manner, the contacts of the electromagnetic relay 202 are controlled to the conductive state when the temperature T is less than 50 °C. When the temperature T is greater than or equal to 200 °C, the contacts of the electromagnetic relay 202 are controlled to the non-conductive state. In the first embodiment, the thresholds Tth1 and Tth2 are both set to 100 °C, as a temperature that meets both of these conditions. Although the threshold Tth2 and the threshold Tth1 are the same (e.g., 100 °C) in the first embodiment, the values may be different. Cases where the threshold Tth2 and the threshold Tth1 are different will be described in detail in the second and subsequent embodiments.

The manner in which the image forming apparatus 10 behaves over time will be described with reference to FIG. 4A. The period from time 0 to time t1 is a period during which the image forming apparatus 10 is printing (the printing state). In this period, the fixing film 102 and the pressurizing roller 107 rotate, and the contacts of the electromagnetic relay 202 are controlled to the conductive state.

At time t1, the image forming apparatus 10 ends the printing and transitions to the standby state. In the period from time t1 to time t2, the fixing film 102 and the pressurizing roller 107 are not rotating, and the temperature T is higher than Tth1. The relay control unit 325 therefore controls the contacts of the electromagnetic relay 202 to the non-conductive state.

At time t2, the temperature T drops below Tth2. The relay control unit 325 controls the contacts of the electromagnetic relay 202 to the conductive state. The relay control unit 325 keeps the electromagnetic relay 202 in that state (the conductive state) from time t2 on.

A case where exogenous noise has occurred in the standby state will be described with reference to FIG. 4B. The solid line represents transitions in the temperature when the temperature T exceeds the threshold Tth1 and the contacts of the electromagnetic relay 202 are controlled to the non-conductive state. The broken line represents transitions in the temperature when the first embodiment, in which the contacts of the electromagnetic relay 202 are controlled to the non-conductive state using the threshold Tth1, is not applied.
When applying first embodiment

The period from time 0 to time t10 is a period during which the image forming apparatus 10 is printing (the printing state). In this period, the fixing film 102 and the pressurizing roller 107 rotate, and the contacts of the electromagnetic relay 202 are controlled to the conductive state. At time t10, the image forming apparatus 10 ends the printing and transitions to the standby state, and the fixing film 102 and the pressurizing roller 107 stop. In the period from time t10 to time t11, the temperature T exceeds the threshold Tth1. The relay control unit 325 therefore controls the contacts of the electromagnetic relay 202 to the non-conductive state.

At time t11, the image forming apparatus 10 begins to be exposed to exogenous noise from the AC power source 201. At this time, the contacts of the electromagnetic relay 202 are controlled to the non-conductive state. The TRIAC 204 therefore does not unintentionally enter the conductive state. Accordingly, no power is supplied from the AC power source 201 to the heater 103 unintentionally, and the temperature T does not start to rise at time t11. The contacts of the electromagnetic relay 202 remain in the non-conductive state until time t13. Time t13 is the time when the temperature T drops below Tth2. Accordingly, the unintentional supply of power from the AC power source 201 to the heater 103 is suppressed during the entire period from time t11 to time t12, which is when the image forming apparatus 10 is exposed to exogenous noise.

When the temperature T drops below the threshold Tth2 at time t13, the relay control unit 325 controls the contacts of the electromagnetic relay 202 to the conductive state. The electromagnetic relay 202 is kept in this state from time t13 on.
When not applying first embodiment

When the first embodiment, in which the contacts of the electromagnetic relay 202 are controlled to the non-conductive state when the temperature T exceeds the threshold Tth1, is not applied, the temperature transitions as indicated by the broken line. When, at time t11, the image forming apparatus 10 is exposed to exogenous noise and the TRIAC 204 conducts unintentionally, power is unintentionally supplied from the AC power source 201 to the heater 103, and the temperature T rises. When the temperature T reaches the threshold Te, the reporting unit 332 reports an error, and the relay control unit 325 controls the contacts of the electromagnetic relay 202 to the non-conductive state. The supply of unintentional power to the heater 103 is stopped as a result. Even if the temperature T reaches Te and the contacts of the electromagnetic relay 202 are controlled to the non-conductive state, the temperature T will reach Tx (e.g., 280 °C) due to temperature overshoot. The fixing film 102 and the pressurizing roller 107 may be damaged as a result. If the temperature overshoot is low, the fixing film 102 and the pressurizing roller 107 will likely not be damaged. However, the image forming apparatus 10 will stop frequently due to exogenous noise. This leads to a decrease in the productivity of the image forming apparatus 10. Accordingly, applying the first embodiment, in which the contacts of the electromagnetic relay 202 are controlled to the non-conductive state when the temperature T exceeds the threshold Tth1, provides many advantages.

A case where the image forming apparatus 10 has been exposed to exogenous noise at a timing when the temperature T is less than the threshold Tth2 while in the standby state will be described with reference to FIG. 4C. The solid line in FIG. 4C represents transitions in the temperature in a case where the contacts of the electromagnetic relay 202 are controlled to the non-conductive state when the temperature T exceeds Tth1, on the basis of the first embodiment. The broken line in FIG. 4C represents transitions in the temperature when the first embodiment is not used.
When applying first embodiment

The solid line in FIG. 4C will be described here. The period from time 0 to time t21 is a period during which the image forming apparatus 10 is printing. In this period, the fixing film 102 and the pressurizing roller 107 rotate, and the contacts of the electromagnetic relay 202 are controlled to the conductive state. At time t21, the image forming apparatus 10 ends the printing and transitions to the standby state. In the period from time t21 to time t22, the temperature T exceeds Tth1 (e.g., 100 °C). The contacts of the electromagnetic relay 202 are therefore controlled to the non-conductive state.

At time t22, the temperature T drops below Tth2 (e.g., 100 °C). The relay control unit 325 therefore controls the contacts of the electromagnetic relay 202 to the conductive state.

At time t23, the image forming apparatus 10 begins to be exposed to exogenous noise. As a result, the TRIAC 204 unintentionally enters a conductive state, and power is supplied from the AC power source 201 to the heater 103 unintentionally. In the period from time t23 to time t24, the temperature T rises due to this unintentional supply of power. When the temperature T exceeds Tth1 at time t24, the relay control unit 325 again controls the contacts of the electromagnetic relay 202 to the non-conductive state. The supply of power from the AC power source 201 to the heater 103 is cut off at time t24, but a temperature overshoot occurs in the period from time t24 to time t25. The temperature T drops after time t25, when the temperature overshoot ends. The exogenous noise continues until time t26. The contacts of the electromagnetic relay 202 remain in the non-conductive state until time t27. Accordingly, the temperature T does not rise again in the period from time t25 to time t26. Because the temperature T falls below 100 °C at time t27, the contacts of the electromagnetic relay 202 are again controlled to the conductive state. In this manner, the contacts of the electromagnetic relay 202 are controlled to the conductive state in the period from time t24 to time t26, and the contacts of the electromagnetic relay 202 are controlled to the non-conductive state in the period from time t22 to time t23 and from time t27 on. This makes it possible to both protect the heating apparatus 100 from exogenous noise and ensure the productivity of the heating apparatus 100.
When not applying first embodiment

Next, a case will be described in which the first embodiment is not applied, and the contacts of the electromagnetic relay 202 are therefore continuously controlled to the conductive state while in the standby state. The broken line in FIG. 4C represents transitions in the temperature in this case.

The TRIAC 204 conducts unintentionally due to exogenous noise at time t23. The temperature T rises as power is unintentionally supplied from the AC power source 201 to the heater 103. When the temperature T exceeds Te (e.g., 250 °C), the reporting unit 332 reports an error, and the relay control unit 325 controls the contacts of the electromagnetic relay 202 to the non-conductive state. The unintentional supply of power from the AC power source 201 to the heater 103 is stopped as a result. However, due to temperature overshoot, the temperature T may reach Tx (e.g., 280 °C), and the fixing film 102 and the pressurizing roller 107 may be damaged as a result. If the temperature overshoot is low, the fixing film 102 and the pressurizing roller 107 will likely not be damaged. However, stopping the image forming apparatus 10 frequently due to exogenous noise impairs the productivity of the image forming apparatus 10. Accordingly, applying the first embodiment, in which the contacts of the electromagnetic relay 202 are controlled to the non-conductive state when the temperature T exceeds the threshold Tth1, provides many advantages.

In this manner, in the standby state in which the fixing film 102 and the pressurizing roller 107 are not rotating, the state of the contacts of the electromagnetic relay 202 is switched on the basis of the thresholds Tth1 and Tth2 provided separate from the threshold Te. This suppresses situations where the image forming apparatus 10 stops frequently due to exogenous noise, and reduces damage to the heating apparatus 100. The FPOT is also shortened.

In the first embodiment, the contact state of the electromagnetic relay 202 is switched by comparing the temperature T and the threshold Tth1, but this is merely one example. In reality, noise removal processing may be applied to the temperature T using a digital filter or the like provided in the controller 205. For example, a digital filter may obtain the temperature T every predetermined period of time (e.g., 10 msec), compare the temperature T with the threshold Tth1, and finalize the comparison result once the comparison result has been the same N consecutive times.

In the first embodiment, the standby state is used as an example of a state in which the fixing film 102 and the pressurizing roller 107 are not rotating, but this is merely one example. The first embodiment can be applied as long as the fixing film 102 and the pressurizing roller 107 are in a non-rotating state. Accordingly, the first embodiment may be applied in a state other than the standby state, such as the sleep state.

In the first embodiment, the CPU 301 (the relay control unit 325) controls the contacts of the electromagnetic relay 202 to the non-conductive state when the temperature T exceeds Tth1 (e.g., 100 °C), but this is merely one example. The entity controlling the electromagnetic relay 202 need not be the CPU 301. For example, the determination unit 313 and the relay control unit 325 may be implemented by a comparison circuit such as a comparator. Then, when the output of the comparator indicates that the temperature T exceeds the threshold Tth1, the contacts of the electromagnetic relay 202 may be controlled to the non-conductive state.

### 1-6. Flowchart

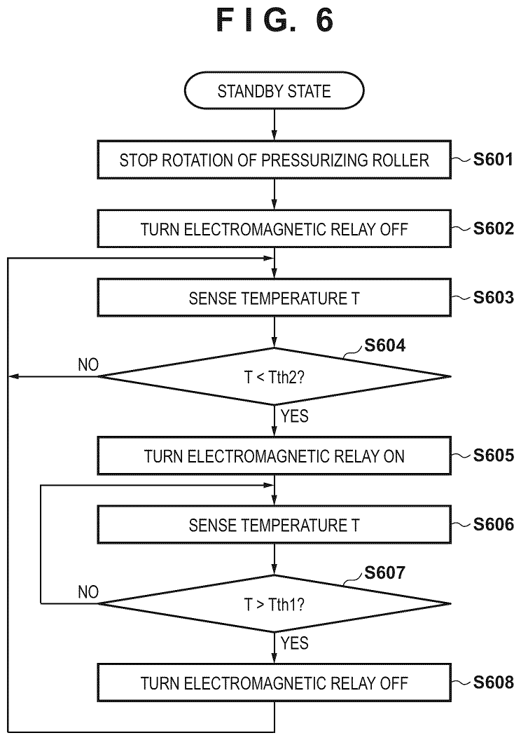

FIG. 6 illustrates a control method executed by the CPU 301 in accordance with a control program. It is assumed here that the printing has ended.

In step S601, the CPU 301 (the motor control unit 327) stops the motor M1 and stops the rotation of the pressurizing roller 107.

In step S602, the CPU 301 (the relay control unit 325) turns the electromagnetic relay 202 off. At this point, the temperature T is the target temperature Ttg for printing.

In step S603, the CPU 301 (the obtainment unit 311) detects the temperature T using the temperature sensor 105. The temperature T may be stored in a random access memory (RAM) region of the memory 302.

In step S604, the CPU 301 (the determination unit 314) determines whether the temperature T is less than the threshold Tth2 (e.g., 100 °C). If the temperature T is not less than the threshold Tth2, the CPU 301 moves the sequence from step S604 to step S603. If the temperature T is less than the threshold Tth2, the CPU 301 moves the sequence from step S604 to step S605. Note that the interval at which the temperature T is measured may be a constant interval.

In step S605, the CPU 301 (the relay control unit 325) turns the electromagnetic relay 202 on. This shortens the startup time of the heater 103.

In step S606, the CPU 301 (the obtainment unit 311) detects the temperature T using the temperature sensor 105. The temperature T may be stored in a random access memory (RAM) region of the memory 302.

In step S607, the CPU 301 (the determination unit 313) determines whether the temperature T exceeds the threshold Tth1 (e.g., 100 °C). If the temperature T exceeds the threshold Tth1, the CPU 301 moves the sequence from step S607 to step S608. Note that the cause of the temperature T exceeding the threshold Tth1 at this timing is the TRIAC 204 conducting unintentionally due to exogenous noise. If the temperature T does not exceed the threshold Tth1, the CPU 301 moves the sequence from step S607 to step S606. Note that the interval at which the temperature T is measured may be a constant interval.

In step S608, the CPU 301 (the relay control unit 325) turns the electromagnetic relay 202 off. As a result, the supply of power to the heater 103 is cut off even if the TRIAC 204 turns on due to exogenous noise. The CPU 301 then moves the sequence from step S608 to step S603.

Note that in the standby state, the CPU 301 monitors for print jobs being loaded. When a print job is loaded, the CPU 301 immediately transitions from the standby state to the printing state. The rotation of the pressurizing roller 107 is started, the electromagnetic relay 202 is turned on, and the temperature control of the heater 103 by the TRIAC 204 is started. The temperature T is controlled to the target temperature Ttg as a result.

Note that the determination as to whether a given value exceeds a corresponding threshold may, in the present specification, be replaced by a determination as to whether the given value is greater than or equal to the threshold. Likewise, the determination as to whether a given value is less than a threshold may be replaced by a determination as to whether the given value is less than or equal to the threshold.

### 2. Second Embodiment

In the first embodiment, the threshold Tth1 and the threshold Tth2 are equal, and thus substantially, the contact state of the electromagnetic relay 202 during the standby state is switched at one temperature threshold. In a second embodiment, the first threshold Tth1 at which the contacts of the electromagnetic relay 202 are controlled to the non-conductive state, and the second threshold Tth2 at which the contacts of the electromagnetic relay 202 are controlled to the conductive state, are different. In other words, two temperature thresholds are used in the second embodiment. Note that the threshold Tth1 is greater than the threshold Tth2. Matters that are the same as in the first embodiment will not be described in the second embodiment.

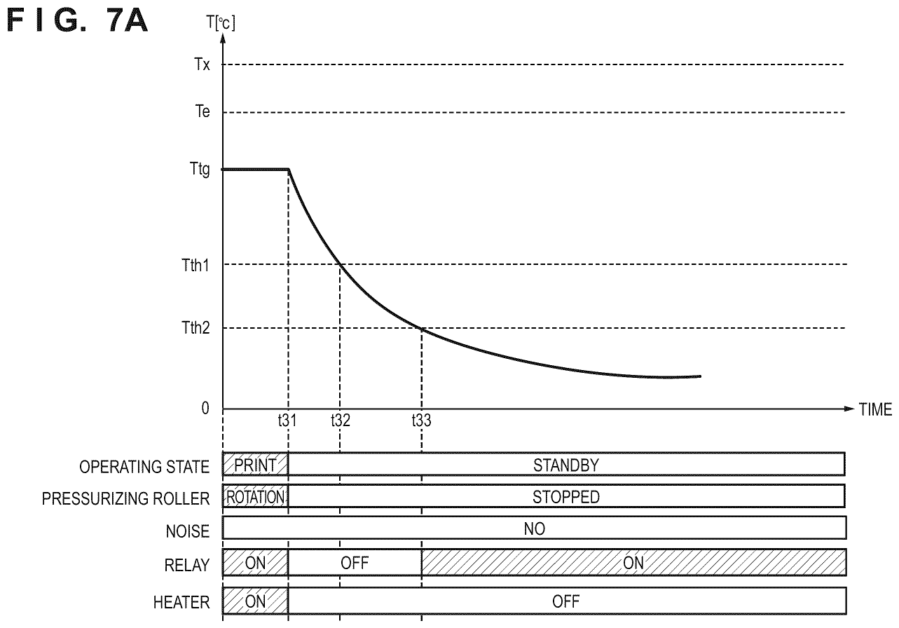

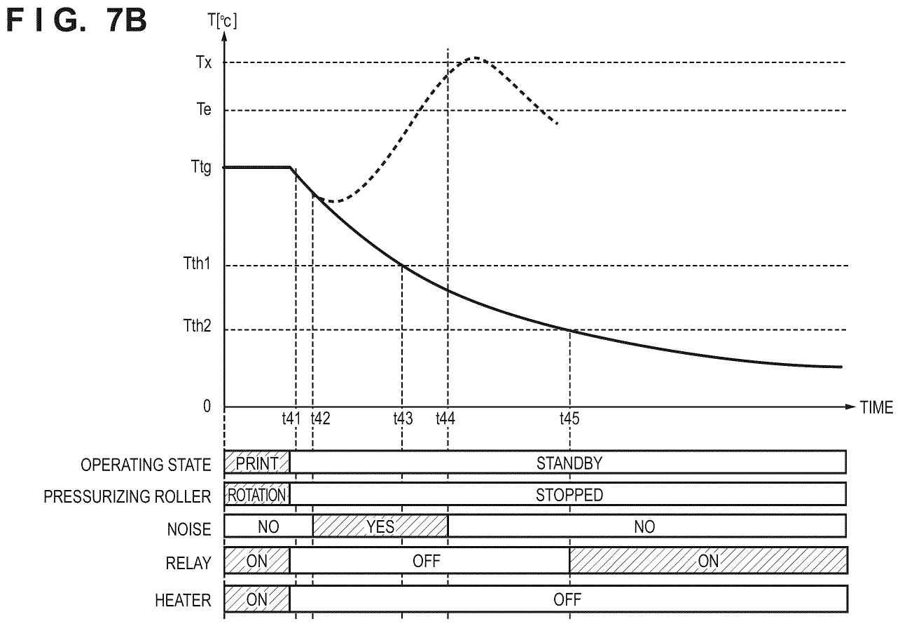

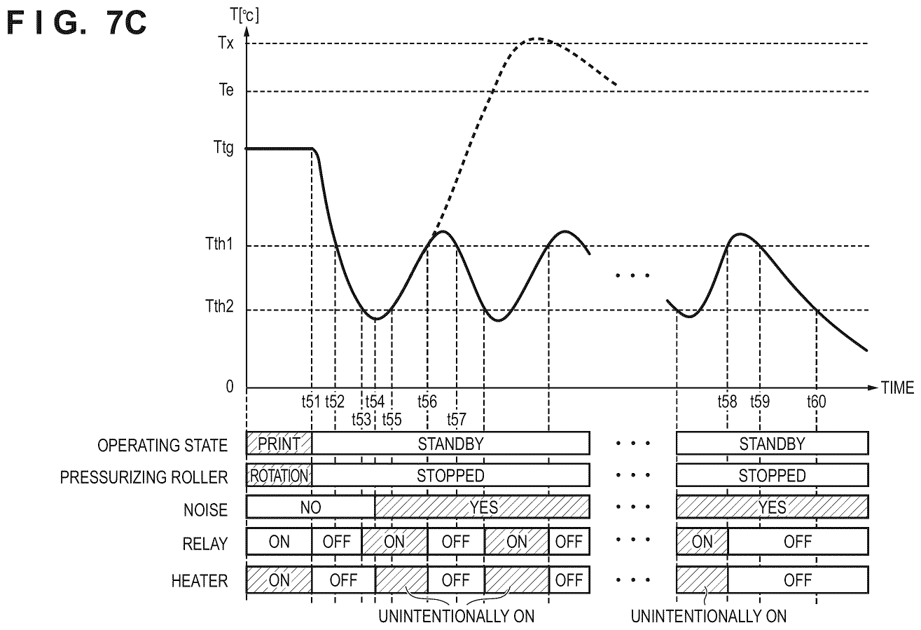

FIGS. 7A to 7C illustrate transitions in the temperature according to the second embodiment. FIG. 7A illustrates a case where the TRIAC 204 has not been exposed to exogenous noise while in the standby state. The threshold Tth1 is 150 °C, for example. Meanwhile, the threshold Tth2 is 70 °C, for example. Here, the thresholds Tth1 and Tth2 are set within a range of from 50 °C to 200 °C. The threshold Tth1 may be set to 150 °C, taking into account a margin with respect to 200 °C (e.g., a margin of 50 °C). The threshold Tth2, too, may be set to 70 °C, taking into account a margin with respect to 50 °C (e.g., a margin of 20 °C). The threshold Tth1 and the threshold Tth2 may be adapted to the configuration of the heating apparatus 100.
When no exogenous noise is present

In FIG. 7A, the period from time 0 to time t31 is a period during which the image forming apparatus 10 is printing (performing image forming operations). In this period, the fixing film 102 and the pressurizing roller 107 rotate, and the contacts of the electromagnetic relay 202 are controlled to the conductive state.

At time t31, the image forming apparatus 10 ends the printing and transitions to the standby state. In the period from time t31 to time t32, the temperature T exceeds the threshold Tth1. The contacts of the electromagnetic relay 202 are therefore controlled to the non-conductive state. In the period from time t32 to t33, the temperature T is greater than or equal to the threshold Tth2 and less than or equal to the threshold Tth1. In this period, the relay control unit 325 keeps the contacts of the electromagnetic relay 202 in the same state as that immediately therebefore. In other words, the contacts of the electromagnetic relay 202 are kept in the non-conductive state.

At time t33, the temperature T drops below the threshold Tth2. The relay control unit 325 therefore controls the contacts of the electromagnetic relay 202 to the conductive state. Even after time t33, the temperature T is less than the threshold Tth2, and thus the contacts of the electromagnetic relay 202 are kept in the conductive state.
When exogenous noise is present during the period when temperature T exceeds threshold Tth2

FIG. 7B illustrates a case where the image forming apparatus 10 is exposed to exogenous noise while in the standby state. The solid line represents transitions in the temperature when the state of the contacts of the electromagnetic relay 202 is controlled using the thresholds Tth1 and Tth2. The broken line represents transitions in the temperature when the second embodiment is not applied.

### 2-1. When Applying Second Embodiment

The period from time 0 to time t41 is a period during which the image forming apparatus 10 is printing. In this period, the fixing film 102 and the pressurizing roller 107 rotate, and the contacts of the electromagnetic relay 202 are controlled to the conductive state. At time t41, the image forming apparatus 10 ends the printing and transitions to the standby state, and the fixing film 102 and the pressurizing roller 107 stop.

In the period from time t41 to time t42, the temperature T exceeds the threshold Tth1. The relay control unit 325 therefore controls the contacts of the electromagnetic relay 202 to the non-conductive state.

Exogenous noise occurs at time t42. Because the contacts of the electromagnetic relay 202 are being controlled to the non-conductive state, power is not supplied to the heater 103 even if the TRIAC 204 unintentionally conducts. In other words, the temperature T does not start to rise at time t42. At time t43, the temperature T drops below the threshold Tth1.

The exogenous noise continues until time t44. However, when the temperature T is less than or equal to the threshold Tth1 and greater than or equal to the threshold Tth2, the contacts of the electromagnetic relay 202 are kept in the same state as that immediately therebefore (the non-conductive state). In this manner, although exogenous noise is present in the period from time t42 to t44, no power is unintentionally supplied from the AC power source 201 to the heater 103.

At time t45, the temperature T drops below the threshold Tth2. The relay control unit 325 switches the contacts of the electromagnetic relay 202 from the non-conductive state to the conductive state. As a result, the startup time of the heater 103 is shortened.

### 2-2. When not Applying Second Embodiment

The broken line in FIG. 7B represents transitions in the temperature when the second embodiment is not applied. In other words, the electromagnetic relay 202 is not turned off using the threshold Tth1, and is not turned on using the threshold Tth2.

At time t42, the TRIAC 204 is exposed to exogenous noise and conducts unintentionally. As a result, power is unintentionally supplied from the AC power source 201 to the heater 103, and the temperature T rises. When the temperature T reaches the threshold Te, the contacts of the electromagnetic relay 202 are controlled to the non-conductive state. The unintentional supply of power from the AC power source 201 to the heater 103 is stopped as a result. However, due to temperature overshoot, the temperature T may reach Tx, and the fixing film 102 and the pressurizing roller 107 may be damaged as a result. Even if the temperature overshoot is low, the image forming apparatus 10 will stop frequently due to exogenous noise. This will likely reduce the productivity of the image forming apparatus 10. Applying the second embodiment therefore provides many advantages. In other words, the life of the heating apparatus 100 is prolonged, and productivity is also improved.
When exogenous noise is present during period when temperature T is less than or equal to threshold Tth2

FIG. 7C illustrates a case where exogenous noise has occurred while in the standby state and when the temperature T is less than the threshold Tth2. The solid line represents transitions in the temperature when the second embodiment is applied. The broken line represents transitions in the temperature when the second embodiment is not applied.

### 2-3. When Applying Second Embodiment

The period from time 0 to time t51 is a period during which the image forming apparatus 10 is printing. In this period, the fixing film 102 and the pressurizing roller 107 rotate, and the contacts of the electromagnetic relay 202 are controlled to the conductive state.

At time t51, the image forming apparatus 10 ends the printing and transitions to the standby state, and the fixing film 102 and the pressurizing roller 107 enter a stopped state. In the period from time t51 to time t52, the temperature T exceeds the threshold Tth1. The contacts of the electromagnetic relay 202 are therefore controlled to the non-conductive state. In the period from time t52 to t53, the temperature T is less than or equal to the threshold Tth1 and greater than or equal to the threshold Tth2. In this period, the contacts of the electromagnetic relay 202 are kept in the same state as that immediately therebefore. In other words, the contacts of the electromagnetic relay 202 are kept in the non-conductive state.

At time t53, the temperature T drops below the threshold Tth2. The relay control unit 325 controls the contacts of the electromagnetic relay 202 to the conductive state. At time t54, the image forming apparatus 10 begins to be exposed to exogenous noise, and the TRIAC 204 unintentionally enters a conductive state. Accordingly, power is supplied from the AC power source 201 to the heater 103 unintentionally. From time t54 on, the temperature T rises due to this unintentional supply of power.

At time t55, the temperature T becomes greater than or equal to the threshold Tth2. In the period where the temperature T is less than or equal to the threshold Tth1 and greater than or equal to the threshold Tth2, the contacts of the electromagnetic relay 202 are kept in the same state as that immediately therebefore. The electromagnetic relay 202 is therefore kept on. As a result, the temperature T rises even more.

At time t56, the temperature T exceeds the threshold Tth1. The relay control unit 325 controls the contacts of the electromagnetic relay 202 to the non-conductive state. The supply of unintentional power to the heater 103 is stopped as a result. However, due to the temperature overshoot, the temperature T continues to rise temporarily. The temperature T drops eventually.

At time t57, the temperature T becomes less than or equal to the threshold Tth1. The electromagnetic relay 202 is kept in the same state as that immediately therebefore. The operations in the period from time t57 to t59 are the same as the operations in the period from time t52 to t57.

### 2-4. Hysteresis Function

The reason why the contacts of the electromagnetic relay 202 are kept in the same state as that immediately therebefore when the temperature T is within the range between the thresholds Tth1 to Tth2 will be explained here. In other words, the contacts of the electromagnetic relay 202 are kept in the state they were in, i.e., conductive state or the non-conductive state, when the temperature T entered a predetermined range. This configuration has two main purposes.

The first purpose is to suppress situations where the contacts of the electromagnetic relay 202 react more sensitively than necessary when noise is added to the temperature T detected by the temperature sensor 105. It is assumed that at the timing when the temperature T is 69 °C, noise is added to the temperature T, and the temperature T is erroneously detected as 71 °C. In this case, the temperature T will quickly return to the original 69 °C. Switching the state of the contacts of the electromagnetic relay 202 in such a case is not an operation which is originally expected to occur. This configuration suppresses oversensitive operations in the electromagnetic relay 202.

The second purpose is to reduce the number of times the electromagnetic relay 202 operates even if the temperature T of the heater 103 unintentionally rises due to exogenous noise. Condition for putting the contacts of the electromagnetic relay 202 into the non-conductive state to begin with may be that the temperature T exceeds the threshold Tth1. Accordingly, there is little advantage in controlling the contacts of the electromagnetic relay 202 to the non-conductive state when the temperature T is trending downward and is also less than or equal to the threshold Tth1. The condition of controlling the contacts of the electromagnetic relay 202 to the conductive state is sufficient as long as the temperature T is less than the threshold Tth2. There is little advantage in controlling the contacts of the electromagnetic relay 202 to the conductive state when the temperature T is trending upward and is also greater than or equal to the threshold Tth2.

Accordingly, when the temperature T is within the range from the threshold Tth2 to the threshold Tth1, the contacts of the electromagnetic relay 202 are kept in the same state as that immediately therebefore. This reduces the number of times the electromagnetic relay 202 operates, and prolongs the time before the electromagnetic relay 202 reaches the end of its service life. The number of times the electromagnetic relay 202 produces operation noise is also reduced. The function by which the contacts of the electromagnetic relay 202 are kept in the same state as that immediately therebefore between the threshold Tth1 and the threshold Tth2 may be called a “hysteresis function”.

### 2-5. Latch Function

Incidentally, exogenous noise may continue for a long period of time. In the period from time t54 to time t58, the number of times that the temperature T transitions from less than the threshold Tth1 to greater than or equal to the threshold Tth1, i.e., the number of times that the contacts of the electromagnetic relay 202 transition from the conductive state to the non-conductive state, may exceed a predetermined number. In this case, the relay control unit 325 does not control the contacts of the electromagnetic relay 202 to the conductive state even if the temperature T again falls below the threshold Tth2. The counter 322 counts the number of times the contacts of the electromagnetic relay 202 have transitioned from the conductive state to the non-conductive state (the count value C). At time t58, the determination unit 319 determines that the count value C has exceeded the threshold Cth, and outputs the determination result to the relay control unit 325. The relay control unit 325 keeps the contacts of the electromagnetic relay 202 in the non-conductive state, even from time t60 on, on the basis of the determination result.

When exogenous noise continues for a long period of time, the contact state of the electromagnetic relay 202 switches repeatedly, the timing at which the electromagnetic relay 202 reaches the end of its service life is accelerated, and the electromagnetic relay 202 produces operation noise many times. Accordingly, when the number of times the state of the contacts of the electromagnetic relay 202 switches (the count value C) is greater than or equal to the threshold Cth, the relay control unit 325 fixes the contacts of the electromagnetic relay 202 to the non-conductive state. This may also be called a “latch function”.

The latch function keeps the contacts of the electromagnetic relay 202 in the non-conductive state, even when the temperature T is less than the threshold Tth2. In this case, it is possible that the FPOT will not be shortened. However, in a situation where the image forming apparatus 10 is exposed to exogenous noise for a long period of time, it is likely better to prioritize protecting the electromagnetic relay 202 and reducing operation noise over shortening the FPOT. From this perspective, the latch function is effective. The CPU 301 may measure the period for which the latch function is active using the timer 323. The CPU 301 may cancel the latch function when the determination unit 319 detects that the timer 323 has timed out. Through this, the latch function may be cancelled automatically when a predetermined period of time has passed following the latch function being activated.

The condition for cancellation may be based on the temperature T. For example, the CPU 301 may cancel the latch function when the temperature T drops below a lower limit value. The lower limit value here is a threshold Tth5. The threshold Tth5 is lower than the threshold Tth2.

### 2-6. Flowchart of Second Embodiment

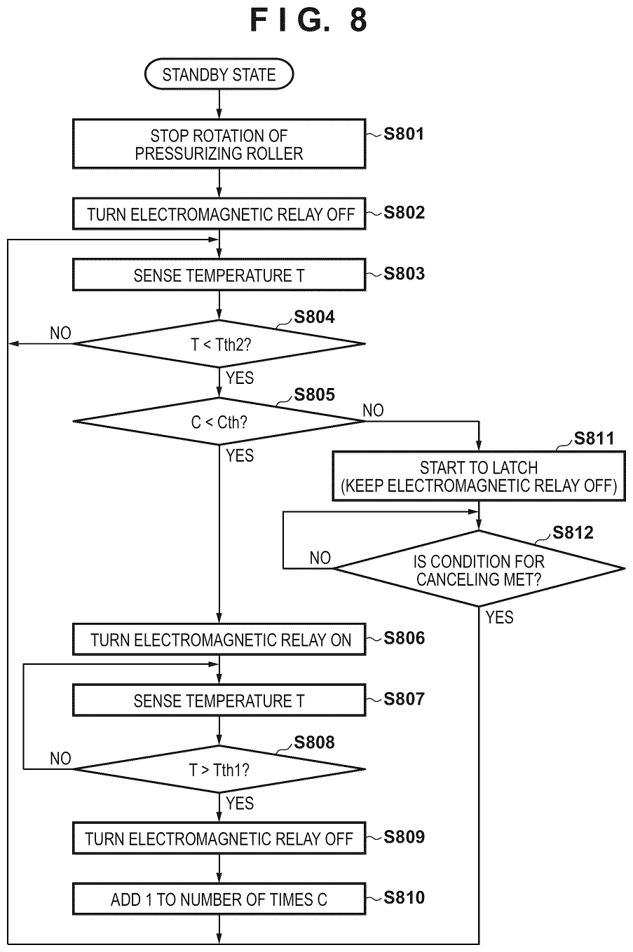

FIG. 8 illustrates a control method executed by the CPU 301 in accordance with a control program. It is assumed here that the printing has ended. The default value of the number C is 0.

In step S801, the CPU 301 (the motor control unit 327) stops the motor M1 and stops the rotation of the pressurizing roller 107.

In step S802, the CPU 301 (the relay control unit 325) turns the electromagnetic relay 202 off. At this point, the temperature T is the target temperature Ttg for printing.

In step S803, the CPU 301 (the obtainment unit 311) detects the temperature T using the temperature sensor 105. The temperature T may be stored in a random access memory (RAM) region of the memory 302.

In step S804, the CPU 301 (the determination unit 314) determines whether the temperature T is less than the threshold Tth2 (e.g., 70 °C). If the temperature T is not less than the threshold Tth2, the CPU 301 moves the sequence from step S804 to step S803. If the temperature T is less than the threshold Tth2, the CPU 301 moves the sequence from step S804 to step S805.

In step S805, the CPU 301 (the determination unit 319) obtains the count value C from the counter 322, and determines whether the count value C is less than the threshold Cth. If the count value C is less than the threshold Cth, the CPU 301 moves the sequence from S805 to S806.

In step S806, the CPU 301 (the relay control unit 325) turns the electromagnetic relay 202 on. This shortens the startup time of the heater 103.

In step S807, the CPU 301 (the obtainment unit 311) detects the temperature T using the temperature sensor 105. The temperature T may be stored in a random access memory (RAM) region of the memory 302.

In step S808, the CPU 301 (the determination unit 313) determines whether the temperature T exceeds the threshold Tth1 (e.g., 105 °C). If the temperature T exceeds the threshold Tth1, the CPU 301 moves the sequence from step S808 to step S809. Note that the cause of the temperature T exceeding the threshold Tth1 at this timing is the TRIAC 204 conducting unintentionally due to exogenous noise. If the temperature T does not exceed the threshold Tth1, the CPU 301 moves the sequence from step S808 to step S807.

In step S809, the CPU 301 (the relay control unit 325) turns the electromagnetic relay 202 off. As a result, the supply of power to the heater 103 is cut off even if the TRIAC 204 turns on due to exogenous noise.

In step S809, the CPU 301 (the counter 322) adds 1 to the count value C. This means that the contacts of the electromagnetic relay 202 have transitioned from the conductive state to the non-conductive state. The CPU 301 then moves the sequence from step S810 to step S803.

Incidentally, if the determination unit 319 determines in step S805 that the count value C is greater than or equal to the threshold Cth, the CPU 301 moves the sequence from step S805 to step S811.

In step S811, the CPU 301 (the relay control unit 325) starts to latch the state of the contacts of the electromagnetic relay 202. This keeps the electromagnetic relay 202 off. The CPU 301 sets a predetermined period of time in the timer 323, and starts the timer 323.

In step S812, the CPU 301 (the determination unit 319) determines whether the condition for canceling the latch function is met. For example, the determination unit 319 determines whether the timer 323 has timed out. When the time measured by the timer 323 reaches the predetermined period of time, the determination unit 319 determines that the cancellation condition has been met, and moves the sequence from step S812 to step S803. The start and cancellation of the latch function may be controlled through such a sequence.

According to the second embodiment, the thresholds Tth1 and Tth2, which are different from the threshold Te, are used in the standby state. This suppresses situations where the image forming apparatus 10 stops frequently due to exogenous noise, and suppresses wear on the heating apparatus 100. The FPOT is also shortened. This is the same as the effects of the first embodiment. According to the second embodiment, the CPU 301 has a hysteresis function. This makes it possible to reduce the number of times the electromagnetic relay 202 operates in an environment where exogenous noise arises. Furthermore, according to the second embodiment, the CPU 301 has a latch function. This makes it possible to reduce the number of times the electromagnetic relay 202 operates in an environment where exogenous noise continues for a longer period of time.

### 3. Third Embodiment

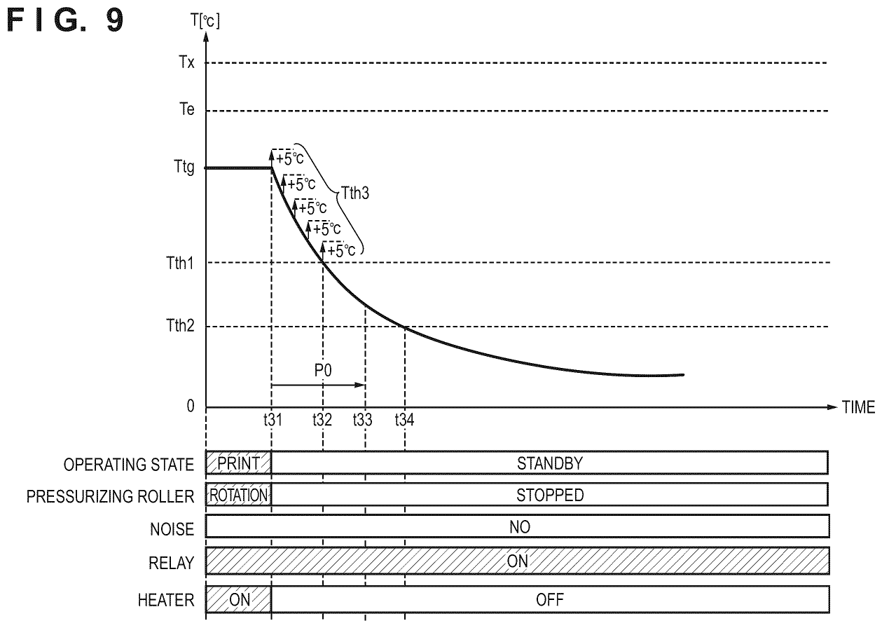

A third embodiment is a control method that takes copy operations into consideration. As illustrated in FIG. 9, processing different from that of the first and second embodiments is executed until a predetermined time P0 (e.g., 60 seconds) has passed after printing has ended. For example, if the temperature T is greater than or equal to the threshold Tth1 (e.g., 150 °C), the relay control unit 325 controls the electromagnetic relay 202 using the third threshold Tth3 instead of the threshold Tth1.

At time t31, the printing ends, and the rotation of the fixing film 102 and the pressurizing roller 107 stops. The setting unit 312 adds a predetermined temperature (e.g., 5 °C) to the current temperature T detected by the temperature sensor 105, and obtains the threshold Tth3. The threshold Tth3 is set in the determination unit 315.

In the period from time t31 to time t32, the temperature T exceeds the threshold Tth1. Accordingly, as the temperature T drops, the setting unit 312 also updates the threshold Tth3 sequentially (e.g., every 500 msec).

The determination unit 315 determines whether the temperature T exceeds the threshold Tth3. When the temperature T exceeds the threshold Tth3, the relay control unit 325 controls the contacts of the electromagnetic relay 202 to the non-conductive state.

The period in which the threshold Tth3 is used instead of the threshold Tth1 is a period (i) before the predetermined time P0 (e.g., 60 seconds) has passed after time t31 when the printing ended and (ii) in which the temperature T is greater than the threshold Tth1. In FIG. 9, the threshold Tth3 is used in the period from time t31 to time t32. In FIG. 9, the temperature T will not exceed the threshold Tth3. Accordingly, in the period from time t31 to time t32, the contacts of the electromagnetic relay 202 are controlled to the conductive state. When the temperature T drops below the threshold Tth1 at time t32, the setting unit 312 stops computing the threshold Tth3. The relay control unit 325 controls the contacts of the electromagnetic relay 202 using the result of the comparison of the temperature T with the threshold Tth1, performed by the determination unit 313.

The hysteresis function described above is activated during the period from time t32 to time t34. Accordingly, the contacts of the electromagnetic relay 202 are kept in the same state as that immediately therebefore (the conductive state).

From time t34 on, the temperature T is less than the threshold Tth2. Accordingly, the contacts of the electromagnetic relay 202 are kept in the conductive state.

In this manner, in FIG. 9, the contacts of the electromagnetic relay 202 are controlled to the conductive state in all periods. In FIG. 9, time t32, when the temperature T drops below the threshold Tth1 for the first time, is earlier than time t33, at which the predetermined time P0 ends. However, time t32, when the temperature T drops below the threshold Tth1 for the first time, may be later than time t33. In this case, at time t33, the relay control unit 325 switches from control using the result of comparing the temperature T with the threshold Tth3 to control using the result of comparing the temperature T with the threshold Tth1.

Although the predetermined time P0 is a fixed time (e.g., 60 seconds) in FIG. 9, this is merely one example. The threshold Tth3 may be used until the time when the temperature T drops below the threshold Tth1 for the first time after printing has ended.

The purpose of using the threshold Tth3 in the predetermined time P0 is to handle copy operations. The image forming apparatus 10 may resume printing after a short period of time (e.g., several seconds to several tens of seconds) passes after printing ends. This is called “intermittent printing”. The image forming apparatus 10 can have a copying function. In copy operations, a first image is read by a document scanner, and the first image is formed on a sheet R. Furthermore, a second image is read, and the second image is formed on a sheet R. In such operations, intermittent printing occurs, in which printing is repeatedly stopped and resumed many times.

As illustrated in FIGS. 7A to 7C, it is assumed here that the contacts of the electromagnetic relay 202 are controlled to the non-conductive state as soon as the printing ends. In this case, intermittent printing results in the state of the contacts of the electromagnetic relay 202 switching frequently. This accelerates the timing at which the electromagnetic relay 202 reaches the end of its service life. The electromagnetic relay 202 also produces operation noise frequently.

Accordingly, in intermittent printing such as copy operations, it can be said that the contacts of the electromagnetic relay 202 should be kept in the conductive state until the predetermined time P0 has elapsed, even after printing ends. In addition, in the predetermined time P0, the threshold Tth3 suppresses an excessive rise in the temperature of the heater 103 caused by exogenous noise.

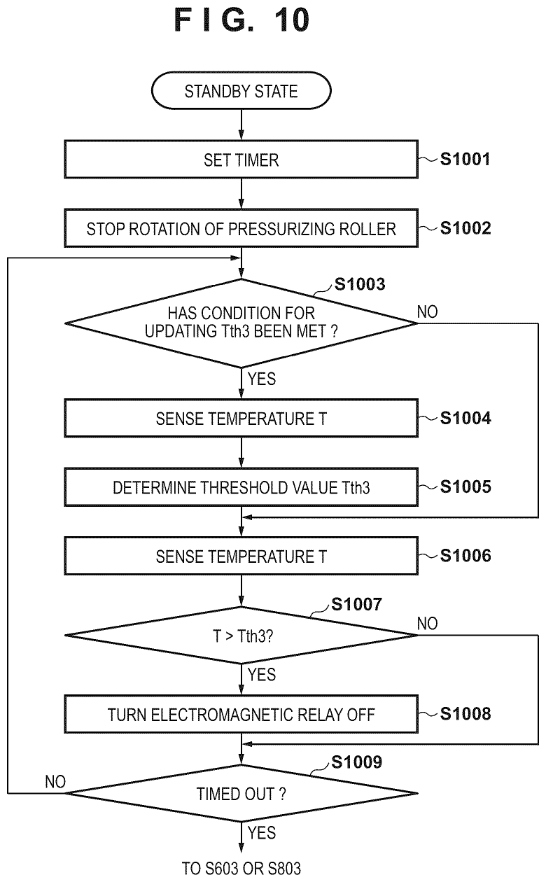

FIG. 10 is a flowchart illustrating the third embodiment. When printing ends, the CPU 301 executes the following processing according to a control program stored in a read-only memory (ROM) region of the memory 302.

In step S1001, the CPU 301 (the setting unit 312) sets the timer 323. For example, the predetermined time P0 is set in the timer 323. In step S1002, the CPU 301 (the motor control unit 327) stops the rotation of the pressurizing roller 107.

In step S1003, the CPU 301 (the setting unit 312) determines whether a condition for updating the threshold Tth3 has been met. For example, the condition for updating may be every predetermined period of time. If the condition for updating is not met, the CPU 301 moves the sequence from step S1003 to step S1006. However, if the condition for updating is met, the CPU 301 moves the sequence from step S1003 to step S1004.

In step S1004, the CPU 301 (the obtainment unit 311) obtains the temperature T using the temperature sensor 105. In step S1005, the CPU 301 (the setting unit 312) determines the threshold Tth3 on the basis of the temperature T. For example, the setting unit 312 may determine the threshold Tth3 by adding a predetermined value (e.g., 5 °C) to the temperature T. The setting unit 312 sets the threshold Tth3 in the determination unit 315.

In step S1006, the CPU 301 (the obtainment unit 311) obtains the temperature T using the temperature sensor 105. In step S1007, the CPU 301 (the determination unit 315) determines whether the temperature T exceeds the threshold Tth3. If the temperature T does not exceed the threshold Tth3, the CPU 301 moves the sequence from step S1007 to step S1009. However, if the temperature T exceeds the threshold Tth3, the CPU 301 moves the sequence from step S1007 to step S1008.

In step S1008, the CPU 301 (the relay control unit 325) turns the electromagnetic relay 202 off on the basis of the determination result from the determination unit 315. In step S1009, the CPU 301 (the determination unit 319) determines whether the timer 323 has timed out. For example, when the time measured by the timer 323 reaches or exceeds the predetermined time P0, the CPU 301 moves the sequence from step S1009 to step S603 (in the first embodiment) or step S803 (in the second embodiment). If the timer 323 has not timed out, the CPU 301 moves the sequence from step S1009 to step S1003. The threshold Tth3 therefore gradually decreases over time.

According to the third embodiment, the threshold Tth3 is used instead of the threshold Tth1 in a certain period after printing has ended. This makes it possible to reduce the number of times the electromagnetic relay 202 operates in intermittent printing, such as copy operations.

### 4. Fourth Embodiment

In the third embodiment, the threshold Tth3 is used instead of the threshold Tth1 in a certain period after printing has ended. This reduces the number of times the electromagnetic relay 202 operates in intermittent printing. In a fourth embodiment, a method of controlling the electromagnetic relay 202 using the combination of the temperature T and the gradient G of the temperature is used as the method for reducing the number of times the electromagnetic relay 202 operates in intermittent printing.

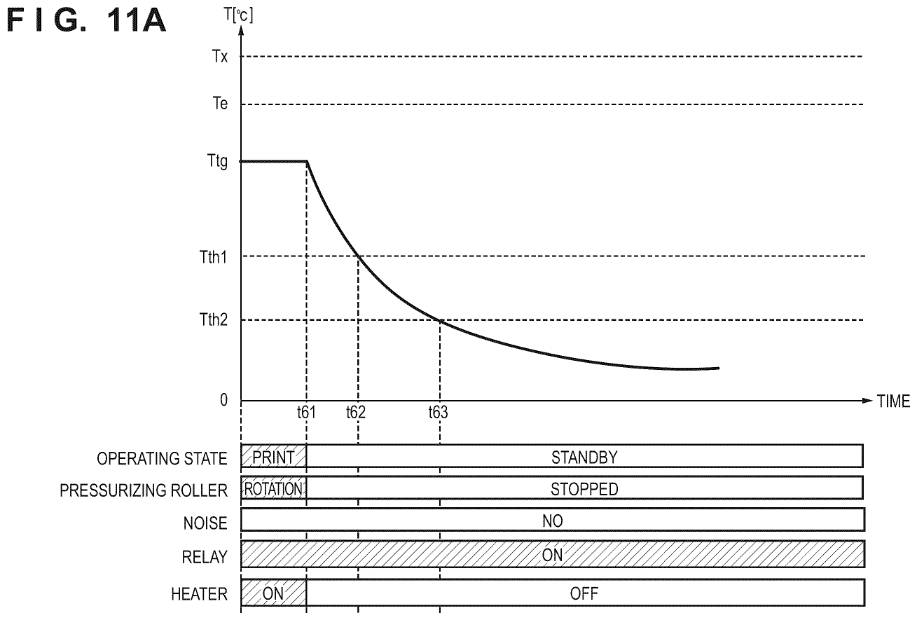

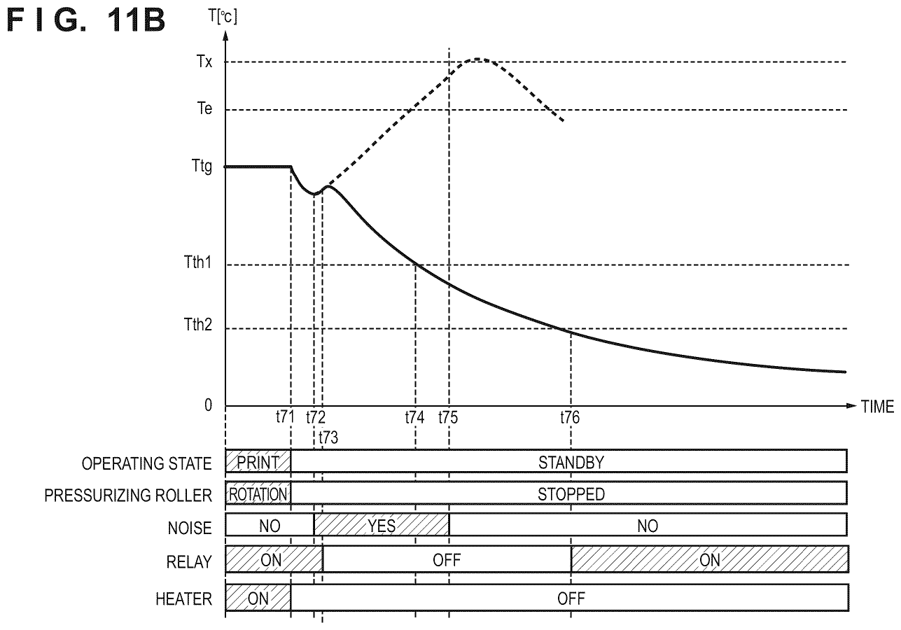

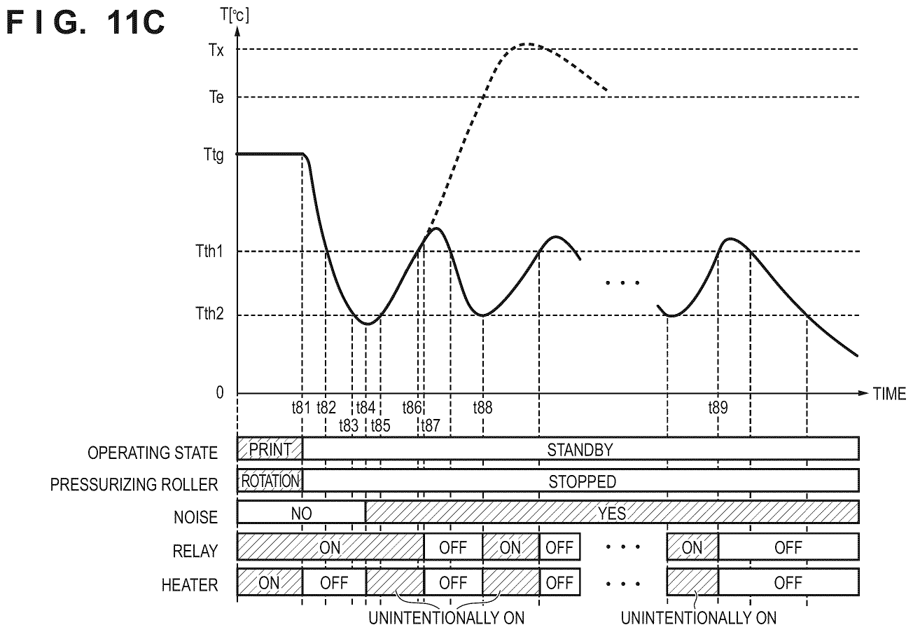

FIGS. 11A to 11C illustrate transitions in the temperature T while in the standby state according to the fourth embodiment. In particular, FIG. 11A illustrates a case where the TRIAC 204 has not been exposed to exogenous noise while in the standby state. In the fourth embodiment, the determination made when the temperature T exceeds the threshold Tth1 (e.g., 150 °C) is different from that in the second and third embodiments. In the second and third embodiments, if the temperature T exceeds the threshold Tth1, the contacts of the electromagnetic relay 202 are controlled to the non-conductive state. In the fourth embodiment, when the temperature T exceeds the threshold Tth1 and the gradient G of the temperature T exceeds the threshold Gth, the contacts of the electromagnetic relay 202 are controlled to the non-conductive state.

For example, the obtainment unit 311 monitors the temperature T by obtaining the temperature T every 20 msec. The obtainment unit 311 furthermore calculates a moving average every 200 msec (a ten-point moving average). The gradient computation unit 321 calculates the gradient G (°C/msec) from the difference between the previous moving average and the current moving average. The threshold Gth is, for example, the gradient when the temperature T has risen by 2 °C over 400 msec. When the determination unit 317 determines that the gradient G exceeds the threshold Gth, the relay control unit 325 controls the contacts of the electromagnetic relay 202 to the non-conductive state. The relay control unit 325 then keeps the contacts of the electromagnetic relay 202 in the non-conductive state, even if the temperature T starts falling instead of rising. However, when the temperature T drops below the threshold Tth2, the relay control unit 325 controls the contacts of the electromagnetic relay 202 to the conductive state.

In FIG. 11A, the image forming apparatus 10 is printing during the period from time 0 to time t61. In this period, the fixing film 102 and the pressurizing roller 107 rotate, and the contacts of the electromagnetic relay 202 are controlled to the conductive state.

At time t61, the image forming apparatus 10 ends the printing and transitions to the standby state. In the period from time t61 to time t62, the temperature T exceeds the threshold Tth1. However, the gradient of the temperature T is negative, and thus the conditions that the temperature T exceeds the threshold Tth1 and the gradient G is positive are not met. Accordingly, the contacts of the electromagnetic relay 202 are kept in the conductive state.

In the period from time t62 to time t63, the previous state is maintained. In other words, the contacts of the electromagnetic relay 202 are kept in the conductive state.

At time t63, the temperature T drops below the threshold Tth2. Here, the contacts of the electromagnetic relay 202 are already in the conductive state. Accordingly, the contacts of the electromagnetic relay 202 are kept in the conductive state even after time t63.
When fourth embodiment is applied (exogenous noise occurs when temperature T is greater than or equal to Tth2)

FIG. 11B illustrates a case where exogenous noise occurs while in the standby state. The solid line represents transitions in the temperature in the case where the fourth embodiment is applied. The broken line represents transitions in the temperature in the case where the fourth embodiment is not applied. The standby state is started from time t71.

In the period from time t71 to time t72, the temperature T exceeds the threshold Tth1, but the gradient G is negative, and the contacts of the electromagnetic relay 202 are therefore kept in the conductive state. Exogenous noise occurs at time t72. As a result, the TRIAC 204 unintentionally enters a conductive state, and the heater 103 starts generating heat. The temperature T therefore rises from time t72 on.

At time t73, the gradient G is determined to have exceeded the threshold Gth, and the contacts of the electromagnetic relay 202 are controlled to the non-conductive state. The heater 103 stops generating heat as a result. The temperature T starts falling after experiencing a temperature overshoot.

In the period from time t74 to time t76, the hysteresis function is active. The contacts of the electromagnetic relay 202 are therefore kept in the non-conductive state.

The exogenous noise ends at time t75. At time t76, the temperature T drops below the threshold Tth2. The contacts of the electromagnetic relay 202 are therefore controlled to the conductive state. This state is maintained from time t76 on.
When fourth embodiment is not applied (exogenous noise occurs when temperature T is greater than or equal to Tth2)

When the fourth embodiment is not applied, the temperature transitions as indicated by the broken line. The behavior of the broken line in FIG. 11B is the same as the behavior of the broken line in FIG. 7B, described in the second embodiment.
When fourth embodiment is applied (exogenous noise occurs when temperature T is less than Tth2)

FIG. 11C illustrates a case where exogenous noise occurs when the temperature T is less than the threshold Tth2 while in the standby state. The solid line represents the case where the fourth embodiment is applied. The broken line represents the case where the fourth embodiment is not applied.

The period from time 0 to time t81 is a period during which the printing is being executed. The standby state starts at time t81. In the period from time t81 to time t82, the temperature T exceeds the threshold Tth1, but the gradient G is less than or equal to the threshold Gth. Accordingly, the contacts of the electromagnetic relay 202 are kept in the conductive state. In the period from time t82 to t83, the temperature T is greater than or equal to the threshold Tth2 and less than or equal to the threshold Tth1. In this period, the hysteresis function is activated, and thus the contacts of the electromagnetic relay 202 are kept in the conductive state.

At time t83, the temperature T drops below the threshold Tth2. However, the contacts of the electromagnetic relay 202 are already in the conductive state. At time t84, exogenous noise occurs, and the TRIAC 204 unintentionally enters a conductive state. As a result, the heater 103 starts generating heat, and the temperature T rises. At time t85, the temperature T is greater than or equal to the threshold Tth2, but the hysteresis function keeps the contacts of the electromagnetic relay 202 in the same state as that immediately therebefore. In the period from time t85 to time t86, power is supplied to the heater 103 due to the exogenous noise. The temperature T therefore continues to rise.

At time t86, the temperature T exceeds the threshold Tth1. Accordingly, the hysteresis function is cancelled, and the monitoring of the gradient G is started.

At time t87, the temperature T exceeds the threshold Tth1, and the gradient G exceeds the threshold Gth. The relay control unit 325 therefore controls the contacts of the electromagnetic relay 202 to the non-conductive state.

Here, the monitoring of the gradient G is started after the temperature T exceeds the threshold Tth1, but this is merely one example. The detection of the temperature T and the detection of the gradient G may be executed sequentially. Alternatively, the temperature T may be compared with the threshold Tth1 after the gradient G exceeds the threshold Gth.

Because the contacts of the electromagnetic relay 202 are controlled to the non-conductive state, the temperature T start falling after experiencing a temperature overshoot. From time t87 to time t88, the hysteresis function keeps the contacts in the non-conductive state.

In the period from time t88 to time t89, the counter 322 described in the third embodiment is applied. In other words, when the number of times the contacts of the electromagnetic relay 202 switch from the conductive state to the non-conductive state (the count value C) exceeds a threshold Cth1, the CPU 301 activates the latch function. From time t89 on, the latch function fixes the contacts of the electromagnetic relay 202 to the non-conductive state. The latch function and the cancellation of the latch function are as described in the third embodiment.

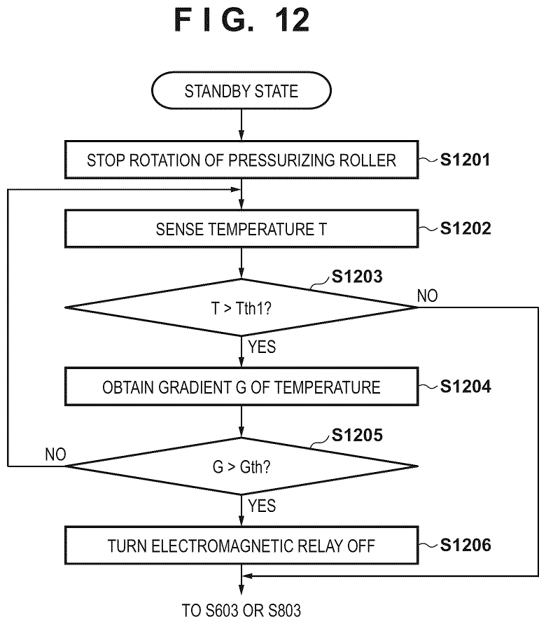

FIG. 12 illustrates a control method according to the fourth embodiment. When printing ends, the CPU 301 executes the following processing according to a control program stored in a read-only memory (ROM) region of the memory 302.

In step S1201, the CPU 301 (the motor control unit 327) stops the rotation of the pressurizing roller 107. In step S1202, the CPU 301 (the obtainment unit 311) obtains the temperature T using the temperature sensor 105.

In step S1203, the CPU 301 (the determination unit 313) determines whether the temperature T exceeds the threshold Tth1. If the temperature T does not exceed the threshold Tth1, the CPU 301 moves the sequence from step S1203 to step S603 or step S803. However, if the temperature T exceeds the threshold Tth1, the CPU 301 moves the sequence from step S1203 to step S1204.

In step S1204, the CPU 301 (the gradient computation unit 321) obtains the gradient G. In step S1205, the CPU 301 (the determination unit 317) determines whether the gradient G exceeds the threshold Gth. For example, whether the gradient G is a positive value may be determined. If the gradient G is a negative value, the CPU 301 moves the sequence from step S1205 to step S1202. However, if the gradient G is a positive value, the CPU 301 moves the sequence from step S1205 to step S1206.

In step S1206, the CPU 301 (the relay control unit 325) turns the electromagnetic relay 202 off. The CPU 301 then moves the sequence from step S1206 to step S603 or step S803.

According to the fourth embodiment, the gradient G is used instead of the threshold Tth3, which is variable. To improve the productivity of intermittent printing, the electromagnetic relay 202 may be kept on even in the standby state. In such a situation, the temperature T of the heater 103 may unintentionally rise due to exogenous noise. In this case, the heater 103 is turned off by monitoring the gradient G. This reduces the number of times the electromagnetic relay 202 operates, suppresses situations where the image forming apparatus 10 stops frequently, and protects the heating apparatus 100.

### 5. Fifth Embodiment

The contacts of the electromagnetic relay 202 may be controlled in accordance with the state of the fixing nip N. During printing, the fixing nip N is formed by the film guide unit 106 being pressed against the pressurizing roller 107 by a spring or the like (not shown). This is called a “contact state”. The force by which the film guide unit 106 is pressed against the pressurizing roller 107 is controlled by the motor M2. When the force of this pressure becomes relatively weak, the fixing nip N becomes narrower or disappears. A state in which the fixing nip N is narrow is called a “pressure-released state”. A state in which the film guide unit 106 and the pressurizing roller 107 are separated and the fixing nip N disappears is called a “separated state”. If the fixing film 102 and the pressurizing roller 107 are in contact with each other for an extended period while stopped in the sleep state, those members may deform. The pressure-released state and the separated state suppress the occurrence of such deformation.

Incidentally, a phenomenon where a sheet R becomes stuck inside the image forming apparatus 10 is called a “jam”. When a jam occurs, it is necessary for the user to remove the sheet R. The pressure-released state and the separated state can facilitate withdrawal of the sheet R from the heating apparatus 100.

Accordingly, when the image forming apparatus 10 transitions to the sleep state, or when a jam occurs, the motor control unit 327 controls the motor M2 to control the heating apparatus 100 to the pressure-released state or a separated state. In the heating apparatus 100 which is in the pressure-released state or the separated state, the contacts of the electromagnetic relay 202 may be controlled to the non-conductive state regardless of the temperature T. Mechanical operating time is required for the heating apparatus 100 to transition from the pressure-released state and the separated state to the printing state (the contact state). This operating time is generally longer than the time required for the contacts of the electromagnetic relay 202 to transition from the non-conductive state to the conductive state. In other words, when transitioning from the pressure-released state and the separated state to the printing state, the operating time of the electromagnetic relay 202 does not act as a bottleneck for the FPOT of the image forming apparatus 10.

The relay control unit 325 may therefore always control the contacts of the electromagnetic relay 202 to the non-conductive state when the heating apparatus 100 is in the pressure-released state or the separated state. As a result, the heater 103 will not generate heat even if the TRIAC 204 turns on due to exogenous noise. This suppresses situations where the image forming apparatus 10 stops frequently, and makes it possible to protect the heating apparatus 100.

### 6. Sixth Embodiment

A sixth embodiment will describe a case where power is intentionally and temporarily supplied to the heater 103 in the standby state. In the standby state, where the fixing film 102 and the pressurizing roller 107 are not rotating, power may be temporarily supplied to the heater 103 for the purpose of cleaning the heating apparatus 100 or the like. This is called “heating during rotation-stopped” or “temporary heating”.

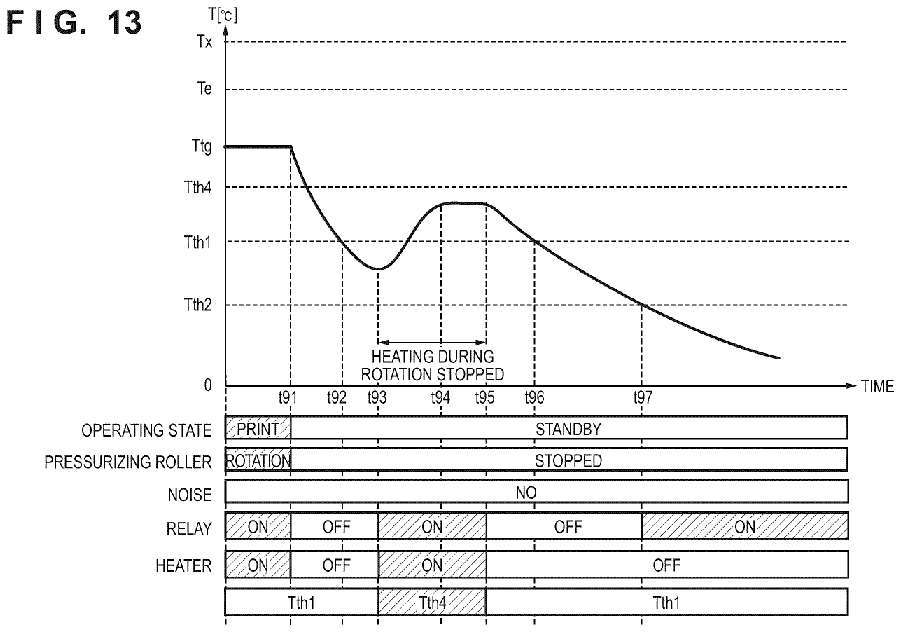

FIG. 13 is a diagram illustrating the temporary heating. In the period from time 0 to time t93, the operations of the second embodiment are applied. At time t93, the CPU 301 starts the temporary heating. At time t93, the CPU 301 changes the temperature threshold for switching the contacts of the electromagnetic relay 202 to the non-conductive state from the threshold Tth1 (e.g., 150 °C) to the fourth threshold Tth4 (e.g., 200 °C). The relay control unit 325 switches the contacts of the electromagnetic relay 202 from the non-conductive state to the conductive state. The relay control unit 325 further controls the TRIAC 204 on the basis of the temperature T, and adjusts the power supplied to the heater 103. The temperature T rises from time t93. At time t94, the temperature T reaches a predetermined temperature. The temperature T is kept at the predetermined temperature from time t94 to time t95.

Note that the determination unit 316 compares the temperature T with the threshold Tth4 during the period from time t93 to time t95. Due to exogenous noise, the TRIAC 204 is continually on, and the temperature T may exceed the threshold Tth4. In this case, the relay control unit 325 may switch the electromagnetic relay 202 off.

The temporary heating is completed at time t95, and the relay control unit 325 turns the TRIAC 204 off. The supply of power to the heater 103 is stopped as a result.

Further, at time t95, the CPU 301 returns the temperature threshold for switching the contacts of the electromagnetic relay 202 to the non-conductive state from Tth4 to Tth1. At time t95, the temperature T exceeds the threshold Tth1. The relay control unit 325 therefore controls the contacts of the electromagnetic relay 202 from the conductive state to the non-conductive state.

The temperature T drops from time t95 on. In the period from time t96 to time t97, the hysteresis function is activated. The contacts of the electromagnetic relay 202 are therefore kept in the non-conductive state. When the temperature T drops below the threshold Tth2 at time t97, the relay control unit 325 controls the contacts of the electromagnetic relay 202 to the conductive state.

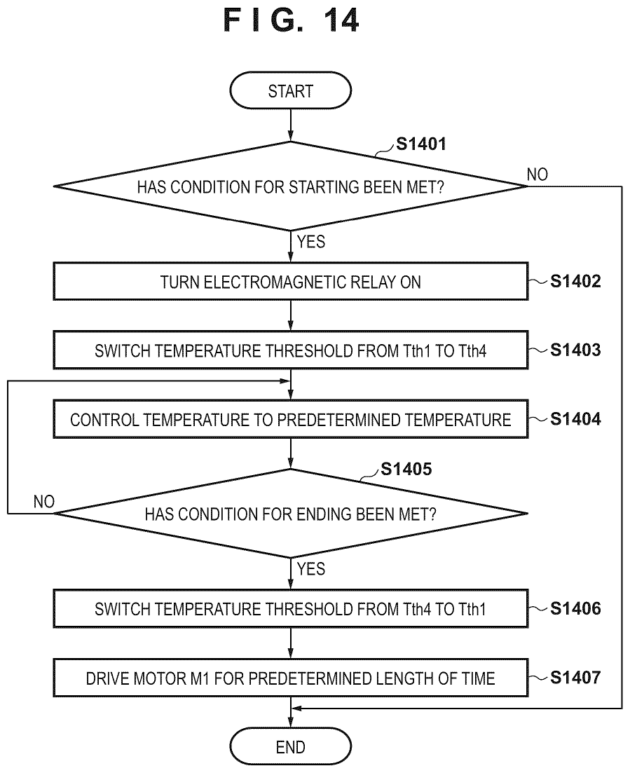

FIG. 14 illustrates a control method according to the sixth embodiment. In the standby state, the CPU 301 executes the following processing in parallel with any of the first to fifth embodiments.

In step S1401, the CPU 301 determines whether a condition for starting the temporary heating has been met. If the condition for starting is met, the CPU 301 moves the sequence from step S1401 to step S1402. The condition for starting may be that the operating time of the heating apparatus 100 has exceeded a predetermined length of time, or that the number of sheets R that have passed through the heating apparatus 100 has exceeded a predetermined number of sheets.

In step S1402, the CPU 301 (the relay control unit 325) turns the electromagnetic relay 202 on. In step S1403, the CPU 301 switches the temperature threshold for turning the electromagnetic relay 202 off from Tth1 to Tth4. For example, the relay control unit 325 may ignore the determination result from the determination unit 313 and use the determination result from the determination unit 316 instead.

In step S1403, the CPU 301 (the relay control unit 325) controls the TRIAC 204 on the basis of the temperature T, and controls the temperature T to a predetermined temperature. In step S1405, the CPU 301 determines whether a condition for ending the temporary heating has been met. If the condition for ending has not been met, the CPU 301 moves the sequence from step S1405 to step S1404. However, if the condition for ending has been met, the CPU 301 moves the sequence from step S1405 to step S1406.

In step S1406, the CPU 301 switches the temperature threshold for turning the electromagnetic relay 202 off from Tth4 to Tth1. In step S1407, the CPU 301 (the motor control unit 327) drives the motor M1 for a predetermined length of time. The motor M1 rotates the fixing film 102 and the pressurizing roller 107 for the purpose of cleaning the heating apparatus 100.

According to the sixth embodiment, the temperature threshold for switching the contacts of the electromagnetic relay 202 to the non-conductive state is temporarily changed. This makes it possible to perform heating during rotation-stopped in the standby state. In other words, not only are the effects described in the first to fifth embodiments achieved, but heating during rotation-stopped is also possible during standby.

### 5. Supplements

According to the embodiments, it is possible to balance the productivity of the heating apparatus 100 with the protection of the components of the heating apparatus 100. This makes it possible to balance the productivity of the image forming apparatus 10 with the protection of the components of the image forming apparatus 10.

As described in the first embodiment, a single threshold may be used. The first threshold and the second threshold are different from the threshold Te for error reporting.

As described in the second and subsequent embodiments, a plurality of thresholds may be used.

The threshold Tth1 may be determined such that any of the fixing film 102, the pressurizing roller 107, the heater 103, and the temperature sensor 105 are less susceptible to heat damage. However, the threshold Tth1 may be determined such that at least one of the fixing film 102, the pressurizing roller 107, the heater 103, and the temperature sensor 105 are less susceptible to heat damage.

The threshold Te is an example of a specified value. The temperature at which damage may occur is Tx, for example.

As illustrated in FIG. 9, P0 is an example of a predetermined period. Tth3 is an example of a third threshold.

As described with reference to FIG. 9, the temperature T becomes less than or equal to the threshold Tth1 for the first time at time t32. Accordingly, the time t32 may be used as the end time of the predetermined period. In this case, the length of the predetermined period is variable.

As described with reference to FIGS. 5A and 5B, the threshold Tth2 may be determined such that the startup time of the heating apparatus 100 does not act as a bottleneck. This further improves the productivity of the heating apparatus 100.

The counter 322 is an example of a counter. As described with reference to FIG. 7C, the CPU 301, the determination unit 318, and the relay control unit 325 function as a latch circuit.

The latch may be cancelled in accordance with an elapsed time. This suppresses a drop in productivity.

The latch may be cancelled in accordance with a temperature. This suppresses a drop in productivity.

In the standby state, the heating apparatus 100 can heat temporarily.

The heating apparatus 100 can be cleaned as well.

The motor M2 is an example of an adjustment unit. A predetermined value is a pressure in the contact state, for example. The pressure at the fixing nip N in the pressure-released state or the separated state is lower than the pressure at the fixing nip N in the contact state.

A first switch may be a switch which has low exogenous noise immunity but which can be operated at a high speed. A second switch may be a switch which operates at a low speed but which has high exogenous noise immunity.

The TRIAC 204, the thyristor, and the like are examples of semiconductor switching elements.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-069199, filed Apr. 22, 2024 which is hereby incorporated by reference herein in its entirety.

What is claimed is:

1. A heating apparatus comprising:
a first rotational member;
a second rotational member that forms a nip with the first rotational member by contacting the first rotational member;
a heating member that heats at least one of the first rotational member and the second rotational member;
a temperature sensor disposed close to any one of the first rotational member, the second rotational member, or the heating member;
a first switch that adjusts power supplied from an AC power source to the heating member; and
a second switch provided in a power supply route along which the power is supplied from the AC power source to the heating member,
wherein a noise immunity of the first switch with respect to exogenous noise coming from the AC power source is lower than a noise immunity of the second switch, and
in a period where the first rotational member and the second rotational member are in a non-rotating state, the second switch:
is controlled to a non-conductive state when a temperature detected by the temperature sensor is greater than a first threshold, without a reporting unit reporting an error pertaining to the temperature; and
is controlled to a conductive state when the temperature detected by the temperature sensor is less than a second threshold that is less than or equal to the first threshold.

2. The heating apparatus according to claim 1,
wherein the first threshold and the second threshold are equal.

3. The heating apparatus according to claim 1,
wherein the first threshold is higher than the second threshold, and
in a case where the temperature is within a range from the first threshold to the second threshold, the second switch is kept in a state, among the conductive state and the non-conductive state, which the second switch was in when the temperature entered the range.

4. The heating apparatus according to claim 1,
wherein the first threshold is set to a temperature such that the second switch switches from the conductive state to the non-conductive state at a timing at which none of the first rotational member, the second rotational member, the heating member, and the temperature sensor are likely to be damaged in a case where, in a period where the first rotational member and the second rotational member are in a non-rotating state, the second switch enters a conductive state, the first switch becomes uncontrollable, and power is supplied from the AC power source to the heating member.

5. The heating apparatus according to claim 4, further comprising:
the reporting unit, which reports the error when the temperature exceeds a specified value,
wherein the first threshold is lower than a temperature at which any one of the first rotational member, the second rotational member, the heating member, or the temperature sensor can be damaged by heat, and is lower than the specified value.

6. The heating apparatus according to claim 1,
wherein the second switch is kept in the conductive state when the first rotational member and the second rotational member transition from a rotating state to a non-rotating state, and
the second switch switches from the conductive state to the non-conductive state when, in a predetermined period after the first rotational member and the second rotational member have transitioned from the rotating state to the non-rotating state, the temperature is greater than a third threshold higher than the first threshold.

7. The heating apparatus according to claim 6,
wherein a length of the predetermined period is a length set in advance.

8. The heating apparatus according to claim 6,
wherein the third threshold is reduced as time passes.

9. The heating apparatus according to claim 6,
wherein the predetermined period is a period from a time when the first rotational member and the second rotational member transition from the rotating state to the non-rotating state to a time when the temperature first drops below the first threshold.

10. The heating apparatus according to claim 1,
wherein the second threshold is determined such that a startup time of the heating apparatus is shorter than a startup time of at least one other process apparatus provided in an image forming apparatus along with the heating apparatus, the startup time of the heating apparatus being a total of (i) an operation time of the second switch when the image forming apparatus in which the heating apparatus is provided starts image forming operations and (ii) a heating time required to control the temperature of the heating member to at least a target temperature.

11. The heating apparatus according to claim 1, further comprising:
a counter that counts a number of times the second switch has transitioned from the conductive state to the non-conductive state in a period where the first rotational member and the second rotational member are in a non-rotating state; and
a latch circuit that latches the second switch in the non-conductive state when the number of times exceeds a predetermined number of times.

12. The heating apparatus according to claim 11,
wherein the latch circuit cancels the latching of the second switch when a predetermined cancellation condition is met after the second switch has been latched in the non-conductive state.

13. The heating apparatus according to claim 12,
wherein the predetermined cancellation condition is that a time for which the second switch has been latched has exceeded a predetermined length of time.

14. The heating apparatus according to claim 12,
wherein the predetermined cancellation condition is that the temperature has become less than a lower limit value that is lower than the second threshold.

15. The heating apparatus according to claim 1, further comprising:
a computing circuit that computes a gradient of the temperature; and
a determination circuit that determines whether the temperature exceeds the first threshold and the gradient exceeds a gradient threshold,
wherein the second switch switches from the conductive state to the non-conductive state when the temperature exceeds the first threshold and the gradient exceeds the gradient threshold.

16. The heating apparatus according to claim 1,
wherein in a case where the temperature is controlled to a predetermined target temperature higher than the first threshold by power being intentionally supplied from the AC power source to the heating member in a period where the first rotational member and the second rotational member are in a non-rotating state, the second switch:
does not switch from the conductive state to the non-conductive state even if the temperature exceeds the first threshold; and
switches from the conductive state to the non-conductive state when the temperature exceeds a fourth threshold higher than the predetermined target temperature.

17. The heating apparatus according to claim 16,
wherein the power is intentionally supplied from the AC power source to the heating member in order to clean the first rotational member and the second rotational member.

18. The heating apparatus according to claim 1, further comprising:
a motor that adjusts a pressure acting between the first rotational member and the second rotational member,
wherein the second switch is controlled to the non-conductive state regardless of the temperature in a case where the pressure is lower than a predetermined value.

19. The heating apparatus according to claim 1,
wherein an operation time of the first switch is shorter than an operation time of the second switch.

20. A heating apparatus comprising:
a first rotational member;
a second rotational member that forms a nip with the first rotational member by contacting the first rotational member;
a heating member that heats at least one of the first rotational member and the second rotational member;
a temperature sensor disposed close to any one of the first rotational member, the second rotational member, or the heating member;
a semiconductor switching element that adjusts power supplied from an AC power source to the heating member; and
an electromagnetic relay provided in a power supply route along which the power is supplied from the AC power source to the heating member,
wherein in a period where the first rotational member and the second rotational member are in a non-rotating state, the electromagnetic relay:
is controlled to a non-conductive state when a temperature detected by the temperature sensor is greater than a first threshold, without a reporting unit reporting an error pertaining to the temperature; and
is controlled to a conductive state when the temperature detected by the temperature sensor is less than a second threshold that is less than or equal to the first threshold.

21. An image forming apparatus comprising:
a transfer member that transfers an image formed from toner onto a sheet; and
a heating apparatus that heats the image transferred onto the sheet to fix the image onto the sheet,
wherein the heating apparatus comprises:
a first rotational member;
a second rotational member that forms a nip with the first rotational member by contacting the first rotational member;
a heating member that heats at least one of the first rotational member and the second rotational member;
a temperature sensor disposed close to any one of the first rotational member, the second rotational member, or the heating member;
a first switch that adjusts power supplied from an AC power source to the heating member; and
a second switch provided in a power supply route along which the power is supplied from the AC power source to the heating member,
wherein a noise immunity of the first switch with respect to exogenous noise coming from the AC power source is lower than a noise immunity of the second switch, and
in a period where the first rotational member and the second rotational member are in a non-rotating state, the second switch:
is controlled to a non-conductive state when a temperature detected by the temperature sensor is greater than a first threshold, without a reporting unit reporting an error pertaining to the temperature; and
is controlled to a conductive state when the temperature detected by the temperature sensor is less than a second threshold that is less than or equal to the first threshold.
